(19) United States
(12) Patent Application Publication
(10) Pub. No.: US 2025/0344017 A1
(43) Pub. Date: Nov. 6, 2025

(54) LOUDSPEAKER ASSEMBLIES AND HEADPHONES

(71) Applicant: SHENZHEN SHOKZ CO., LTD., Shenzhen (CN)

(72) Inventors: Guangyuan ZHU, Shenzhen (CN); Lei ZHANG, Shenzhen (CN); Xin QI, Shenzhen (CN)

(73) Assignee: SHENZHEN SHOKZ CO., LTD., Shenzhen (CN)

(21) Appl. No.: 19/273,121

(22) Filed: Jul. 17, 2025

Related U.S. Application Data
(63) Continuation of application No. PCT/CN2023/126027, filed on Oct. 23, 2023.

(51) Int. Cl. H04R 1/32; H04R 1/02

(52) U.S. Cl. CPC H04R 1/323; H04R 1/02; H04R 2460/01; H04R 2460/13

(57) ABSTRACT

A loudspeaker assembly and a headphone are provided. The headphone includes a housing assembly, a bone-conduction core module, and an air-conduction core module, and an accommodation space. The bone-conduction core module is provided in the accommodation space and vibrates in a first vibration direction, the air-conduction core module is provided in the accommodation space, and the bone-conduction core module and the air-conduction core module are arranged along the first vibration direction and face each other. In the above manner, the present disclosure reduces the influence of the air-conduction core module on the vibration effect of the bone-conduction core module, increases the sound volume, and improves the bone-conduction effect of the loudspeaker assembly, thereby improving the sound quality effect of the loudspeaker assembly.

### CROSS-REFERENCE TO RELATED APPLICATION

This application is a continuation of International Application No. PCT/CN2023/126027, filed on Oct. 23, 2023, the contents of which are incorporated herein by reference.

### TECHNICAL FIELD

The present disclosure relates to the technical field of electronic devices, and in particular, to loudspeaker assemblies and headphones.

### BACKGROUND

Headphones have become an indispensable tool for social interaction and entertainment in people's daily lives, enjoying widespread global adoption. As user expectations for electronic devices continue to rise, headphones combining both air-conduction and bone-conduction technologies have gained popularity due to their superior audio quality and enhanced user experience.

As the bone-conduction technology requires the headphone to vibrate and transmit vibration signals to the human body, when the bone-conduction loudspeaker vibrates along its axis, it may drive the housing assembly to vibrate, and the air-conduction loudspeaker and the housing assembly may become vibration loads. The air-conduction loudspeaker is usually set next to the axis of the bone-conduction loudspeaker, in which case the mass of the air-conduction loudspeaker biases the vibration of the bone-conduction loudspeaker to make the loudspeaker generate two different torques in different directions. This results in the weakening of the vibration of the bone-conduction loudspeaker along the axis and a decrease in the volume of the bone-conduction loudspeaker of the headphone, thereby leading to a decrease in the volume of the headphone and affecting the sound quality of the headphone.

### SUMMARY

The present disclosure provides a loudspeaker assembly and a headphone, which reduces the impact of vibration effects of air-conduction core modules on bone-conduction core modules, increases the volume, and increases the bone-conduction effect of the loudspeaker assembly, thereby improving the sound quality effect of the loudspeaker assembly.

In order to solve the above technical problem, one technical solution in the present disclosure is to provide a loudspeaker assembly that includes a housing assembly, a bone-conduction core module, and an air-conduction core module.

The housing assembly may be provided with an accommodation space. The bone-conduction core module may be provided in the accommodation space and vibrate in a first vibration direction. The air-conduction core module may be provided in the accommodation space, and the air-conduction core module and the bone-conduction core module may be arranged along the first vibration direction and face each other.

In some embodiments, a projection of the bone-conduction core module on a reference plane perpendicular to the first vibration direction may have an overlapping region with a projection of the air-conduction core module on the reference plane perpendicular to the first vibration direction.

In some embodiments, a ratio of an area of the overlapping region to an area of the projection of the air-conduction core module on the reference plane may be greater than 20%, or greater than 40%, or greater than 60%.

A ratio of the area of the overlapping region to the area of the projection of the bone-conduction core module on the reference plane may be greater than 20%, or greater than 40%, or greater than 60%.

In some embodiments, the air-conduction core module may be stacked on the bone-conduction core module along the first vibration direction.

In some embodiments, the air-conduction core module may be fixedly connected to the bone-conduction core module.

In some embodiments, a resilient cushioning member may be provided between the air-conduction core module and the bone-conduction core module.

In some embodiments, the air-conduction core module may be spaced apart from the bone-conduction core module in the first vibration direction.

In some embodiments, the housing assembly may be provided with a partition wall, and the accommodation space may include a first accommodation cavity and a second accommodation cavity spaced apart by the partition wall. The bone-conduction core module may be provided in the first accommodation cavity, and the air-conduction core module may be provided in the second accommodation cavity.

In some embodiments, the housing assembly includes a first housing, a second housing, and a third housing. The second housing may be connected to the first housing and cooperate with the first housing to form the first accommodation cavity. The third housing may be connected to the first housing and the second housing, respectively, and cooperate with the first housing to form the second accommodation cavity.

In some embodiments, the bone-conduction core module may have a first central axis extending along the first vibration direction. The air-conduction core module may vibrate in a second vibration direction and have a second central axis extending along the second vibration direction. An angle between the first central axis and the second central axis may be within a range of 70°-100°. The third housing may be located on a side of the first housing away from the second housing in the first vibration direction. A cross-section of the third housing in a direction perpendicular to the first vibration direction may progressively decrease or decrease stepwise in a direction away from the second housing.

In some embodiments, the second housing may have a contact region contacting the face of a user in a wearing state. A joint seam between the first housing and the second housing may be located outside the contact region.

In some embodiments, the air-conduction core module may vibrate in a second vibration direction. The housing assembly may be provided with a sound outlet hole and a pressure relief hole that are in flow communication with the second accommodation cavity. The sound outlet hole and the pressure relief hole may be provided on two sidewalls of the housing assembly spaced apart from each other in the second vibration direction, respectively.

In some embodiments, a shape and a size of the first accommodation cavity may match a shape and a size of the bone-conduction core module.

In some embodiments, at least one of the air-conduction core module and the bone-conduction core module may be fixed relative to the housing assembly.

In some embodiments, the bone-conduction core module may have a sealed structure, with an interior of the bone-conduction core module being isolated from the accommodation space.

In some embodiments, the bone-conduction core module includes a cylindrical housing, a drive assembly, and two sealing plates. The cylindrical housing may be fixedly connected to the housing assembly, the drive assembly may be provided within the cylindrical housing and is configured to drive the cylindrical housing to vibrate and thereby drive the housing assembly to vibrate. The two sealing plates may be disposed at two ends of the cylindrical housing and configured to seal the cylindrical housing to form the sealed structure.

In some embodiments, the bone-conduction core module may include a vibration transmission plate. The drive assembly may include a voice coil assembly and a magnet assembly. The voice coil assembly may be sleeved on the magnet assembly. The vibration transmission plate may be fixedly connected between the cylindrical housing and the magnet assembly. The voice coil assembly may be fixedly connected to the cylindrical housing.

In some embodiments, an inner space of the cylindrical housing may be filled with a magnetic fluid, and the magnetic fluid may occupy at least a portion of the inner space of the cylindrical housing.

In some embodiments, a distance between a projection of a center of mass of the bone-conduction core module on a reference plane perpendicular to the first vibration direction and a projection of a center of mass of the air-conduction core module on the reference plane may be less than 0.5 mm. Alternatively, the bone-conduction core module may have a first central axis extending along the first vibration direction, and a distance between the center of mass of the air-conduction core module and the first central axis may be less than or equal to 0.5 mm.

In some embodiments, the distance may be within a range of 0-0.4 mm or 0-0.2 mm.

In some embodiments, the air-conduction core module may vibrate in the second vibration direction. An angle between the first vibration direction and the second vibration direction may be within a range of 70-100° or 80°-90°.

In some embodiments, the housing assembly may be provided with a first side surface, a second side surface, and a vibration transmitting surface. The first side surface, the second side surface, and the vibration transmitting surface may not be coplanar. The first side surface and the second side surface may be spaced apart in a direction perpendicular to the first vibration direction. The housing assembly may be provided with a sound outlet hole penetrating the first side surface and in flow communication with the accommodation space, and a pressure relief hole penetrating the second side surface and in flow communication with the accommodation space. The vibration transmitting surface may be perpendicular to the first vibration direction. The bone-conduction core module may transmit vibration outwardly through the vibration transmitting surface.

In order to solve the above-described technical problem, another solution in the present disclosure is to provide a loudspeaker assembly. The loudspeaker assembly may include a casing assembly, a bone-conduction core module, and an air-conduction core module. The housing assembly may be provided with an accommodation space. The bone-conduction core module may be provided in the accommodation space and vibrate in a first vibration direction. The air-conduction core module may be provided in the accommodation space.

The air-conduction core module and the bone-conduction core module may be arranged along the first vibration direction, and a projection of the bone-conduction core module on a reference plane perpendicular to the first vibration direction may have an overlapping region with a projection of the air-conduction core module on the reference plane perpendicular to the first vibration direction. A ratio of an area of the overlapping region to an area of the projection of the air-conduction core module on the reference plane or a ratio of the area of the overlapping region to an area of the projection of the bone-conduction core module on the reference plane may be greater than 20%, or greater than 40%, or greater than 60%.

In order to solve the above-described technical problem, another solution in the present disclosure is to provide a headphone including a loudspeaker assembly as described above.

The present disclosure has the following beneficial effects. By providing the air-conduction core module and the bone-conduction core module in the first vibration direction of the bone-conduction core module and arranging the air-conduction core module and the bone-conduction core module along the first vibration direction and to face each other, the air-conduction core module may be more concentrated on the axis of the bone-conduction core module. Thus, the biasing effect of the air-conduction core module on the bone-conduction core module vibration is weakened, making the bone-conduction core module better drive the air-conduction core module during vibration. Additionally, the effect of the mass of the air-conduction core module on the vibration effect of the bone-conduction core module is reduced, which increases the volume of the sound, thereby increasing the bone-conduction effect of the loudspeaker assembly, so as to improve the sound quality effect of the loudspeaker assembly.

### BRIEF DESCRIPTION OF THE DRAWINGS

FIG. 1 is a schematic diagram illustrating an overall three-dimensional structure of a headphone according to some embodiments of the present disclosure;

FIG. 2 is a schematic diagram illustrating a three-dimensional structure of a loudspeaker assembly and a part of an ear hook according to some embodiments of the present disclosure;

FIG. 3a is a schematic diagram illustrating an exploded view of a loudspeaker assembly shown in FIG. 2;

FIG. 3b is a schematic diagram illustrating an exploded view of another loudspeaker assembly shown in FIG. 2

FIG. 4 is a schematic diagram illustrating a cross-sectional structure of a loudspeaker assembly in FIG. 2 along an A-A section line;

FIG. 5a is a schematic diagram illustrating another cross-sectional structure of the loudspeaker assembly in FIG. 2 along the A-A section line;

FIG. 5b is a schematic diagram illustrating yet another cross-sectional structure of the loudspeaker assembly in FIG. 2 along the A-A section line

FIG. 6 is a schematic diagram illustrating another three-dimensional structure of the loudspeaker assembly in FIG. 2;

FIG. 7 is a schematic diagram illustrating a positional relationship between a first central axis and a second central axis of the loudspeaker assembly in FIG. 2;

FIG. 8 is a schematic diagram illustrating an exploded view of a bone-conduction loudspeaker in FIG. 3a;

FIG. 9 is a schematic diagram illustrating a cross-sectional structure of the bone-conduction loudspeaker in FIG. 8 along a B-B section line;

FIG. 10 is a schematic diagram illustrating a three-dimensional structure of an air-conduction loudspeaker in FIG. 3a;

FIG. 11 is a schematic diagram illustrating an exploded view of the air-conduction loudspeaker in FIG. 10;

FIG. 12 is a schematic diagram illustrating an exploded view of yet another loudspeaker assembly in FIG. 2;

FIG. 13 is a schematic diagram illustrating a cross-sectional structure of the loudspeaker assembly in FIG. 12 along the A-A section line of one embodiment;

FIG. 14 is a schematic diagram illustrating a cross-sectional structure of the loudspeaker assembly in FIG. 12 along the A-A section line of another embodiment;

FIG. 15 is a schematic diagram illustrating a cross-sectional structure of the loudspeaker assembly in FIG. 12 along the A-A section line of yet another embodiment;

FIG. 16 is a schematic diagram illustrating a vibration transmission plate in the bone-conduction loudspeaker shown in FIG. 8;

FIG. 17 is a schematic diagram illustrating an exploded view of yet another loudspeaker assembly of the present disclosure;

FIG. 18 is a schematic diagram illustrating a cross-sectional structure of the loudspeaker assembly in FIG. 17 along a C-C section line of one embodiment;

FIG. 19 is a schematic diagram illustrating a cross-sectional structure of the loudspeaker assembly in FIG. 17 along a C-C section line of another embodiment;

FIG. 20 is a schematic diagram illustrating a cross-sectional structure of the loudspeaker assembly in FIG. 17 along a C-C section line of yet another embodiment; and

FIG. 21 is a schematic diagram illustrating another cross-sectional structure of the loudspeaker assembly in FIG. 17 along the C-C section line.

### DETAILED DESCRIPTION

The present disclosure is described in further detail below in conjunction with the accompanying drawings and embodiments. In particular, it is noted that the following embodiments are only used to illustrate the present disclosure, but do not limit the scope of the present disclosure. Similarly, the following embodiments are only part of the embodiments of the present disclosure rather than all of the embodiments, and all other embodiments obtained by a person of ordinary skill in the art without creative labor fall within the scope of protection of the present disclosure.

References to “embodiments” in the present disclosure mean that particular features, structures, or characteristics described in conjunction with embodiments may be included in at least one embodiment of the present disclosure. It is understood by those of skill in the art, both explicitly and implicitly, that the embodiments described in the present disclosure may be combined with other embodiments.

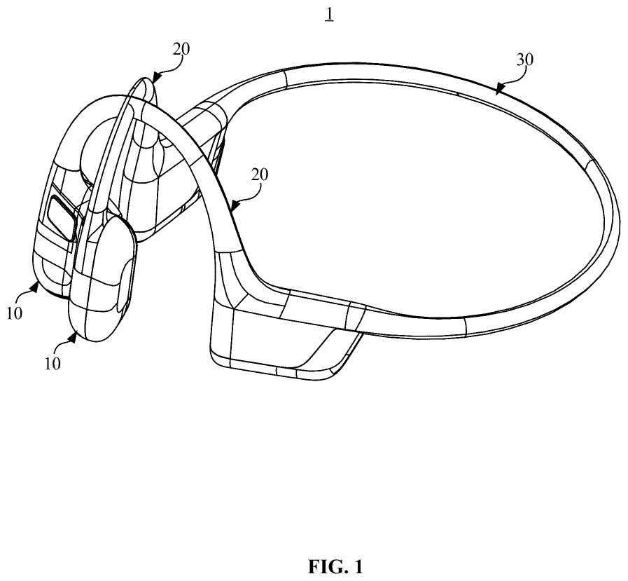

As shown in FIG. 1, the headphone 1 may include a loudspeaker assembly 10, an ear hook 20, and a rear hook 30.

The loudspeaker assembly 10 may include a core module including a loudspeaker and a corresponding assembly housing, a circuit device, or the like. The headphone 1 may include two loudspeaker assemblies 10. The two loudspeaker assemblies 10 are used for transmitting vibration and/or sound to the user's left ear and right ear, respectively. The two loudspeaker assemblies 10 may be the same or different. For example, one loudspeaker assembly 10 may be provided with a microphone, and the other loudspeaker assembly 10 may not be provided with a microphone. In some embodiments, both loudspeaker assemblies 10 may be provided with microphones. As another example, one loudspeaker assembly 10 may be provided with a key and a corresponding circuit board, and the other loudspeaker assembly 10 may not be provided with a key and the corresponding circuit board. The loudspeakers included in the two loudspeaker assemblies 10 may be the same or different. The loudspeaker assemblies 10 may be described in detail by taking one of the two loudspeaker assemblies 10 as an example.

The headphone 1 may include two ear hooks 20, and the two ear hooks 20 may be located in the user's left and right ears, respectively, to enable the loudspeaker assembly 10 to fit the user's face. For example, one ear hook 20 may be provided with a battery, and the other ear hook 20 may be provided with a control circuit, or the like. One end of the ear hook 20 is connected to the loudspeaker assembly 10, and the other end of the ear hook 20 is connected to the rear hook 30. The ear hook 20 may also be referred to as a wearing assembly 20.

The rear hook 30 may be connected to two ear hooks 20, and the rear hook 30 may be configured to wrap around the back of the user's neck or back of the user's head and provide clamping force to allow the two loudspeaker assemblies 10 to be clamped to two sides of the user's face and the ear hooks 20 to hang more securely to the user's ears. In some embodiments, the headphone 1 may not include the rear hook 30, with the loudspeaker assemblies 10 being worn on the user's ears via the ear hooks 20.

In some embodiments, the headphone 1 may not include a rear hook 30, and the loudspeaker assembly 10 is worn on the user's ear via the ear hook 20. Alternatively, in some embodiments, the headphone 1 may not include the ear hook 20, and the loudspeaker assembly 10 is connected to a headband structure or a neck-hanging structure. The loudspeaker assembly 10 is pressed against the user's face or firmly placed outside the user's ear through the headband structure or the neck-hanging structure.

The following describes, mainly and exemplarily, a structure such as the loudspeaker assembly 10 of the headphone 1.

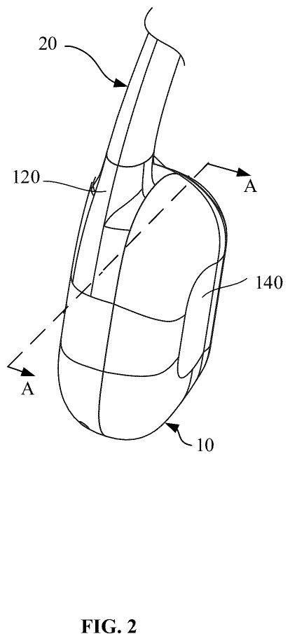

As shown in FIG. 2 to FIG. 4, the loudspeaker assembly 10 includes a housing assembly 100, a bone-conduction loudspeaker 200, and an air-conduction loudspeaker 300. The housing assembly 100 may be provided with an accommodation space 110. The air-conduction loudspeaker 300 may be provided in the accommodation space 110, and the bone-conduction loudspeaker 200 may be provided in the accommodation space 110.

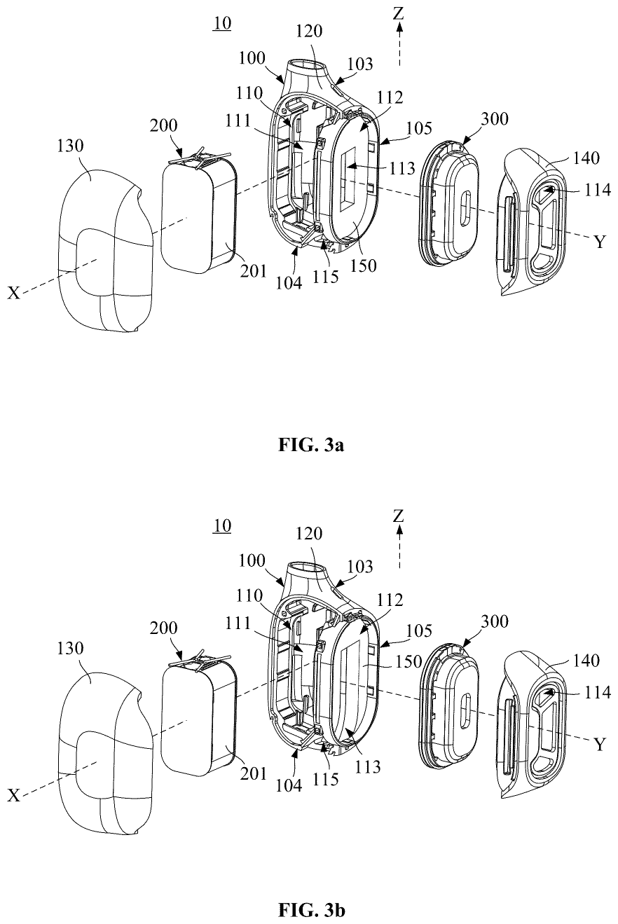

The accommodation space 110 is formed within the housing assembly 100, and the accommodation space 110 accommodates the air-conduction loudspeaker 300 and the bone-conduction loudspeaker 200. The accommodation space 110 may be a single large space or may be separated into two or more connected or disconnected small spaces. For example, in the embodiment shown in FIG. 3a, the housing assembly 100 may have a first accommodation space 111 and a second accommodation space 112. The first accommodation space 111 and the second accommodation space 112 may be two spaces that are connected or not connected.

In some embodiments, as shown in FIG. 3a, the housing assembly 100 may also be provided with a connecting hole 113 through which the first accommodation cavity 111 is in flow communication with the second accommodation cavity 112. In such a case, at least the first accommodation cavity 111, the second accommodation cavity 112, and the connecting hole 113 may together form the accommodation space 110. The bone-conduction loudspeaker 200 may be provided within the first accommodation cavity 111 and block the connecting hole 113 so that the first accommodation cavity 111 and the second accommodation cavity 112 are isolated from each other. The air-conduction loudspeaker 300 may be provided within the second accommodation cavity 112. In other embodiments, the connecting hole 113 may not be provided between the first accommodation cavity 111 and the second accommodation cavity 112, and the housing assembly 100 isolates the two from each other.

The air-conduction loudspeaker 300 is configured to conduct sound into the ear canal of the user through air vibration, and the bone-conduction loudspeaker 200 is configured to conduct sound into the user through bone-conduction vibration. Because the second accommodation cavity 112 in which the air-conduction loudspeaker 300 is located needs to be in flow communication with the outside world to facilitate the conduction of the sound waves through the air, and the bone-conduction loudspeaker 200 needs an environment having a great sealing performance to ensure the effect of the bone conduction, setting the bone-conduction loudspeaker 200 and the air-conduction loudspeaker 300 independently in two different cavities in the accommodation space 110 can effectively reduce the mutual interference between the bone-conduction loudspeaker 200 and the air-conduction loudspeaker 300, thereby effectively improving the sound quality of the headphone 1. The sealing performance may be understood as the airtightness of the cavity space.

On the basis of the above description, by providing the connecting hole 113 between the first accommodation cavity 111 and the second accommodation cavity 112 and using the bone-conduction loudspeaker 200 to block the connecting hole 113 on one side of the connecting hole 113, the strong sealing performance of the second accommodation cavity 112 may be ensured and the use space of the first accommodation cavity 111 is expanded, which may effectively improve the convenience of assembly of the air-conduction loudspeaker 300 and the reliability of the structural setup. In addition, the volume of the sound cavity space formed by the air-conduction loudspeaker 300 in the second accommodation cavity 112 can be simply and effectively expanded, which may enhance the acoustic effect of the air-conduction loudspeaker 300, improving the sound quality of the air-conduction loudspeaker 300. In other words, the air-conduction loudspeaker 300 may be set closer to the bone-conduction loudspeaker 200 while keeping the volume of the sound cavity space unchanged, reducing the size of the loudspeaker assembly 10 and realizing a compact overall size.

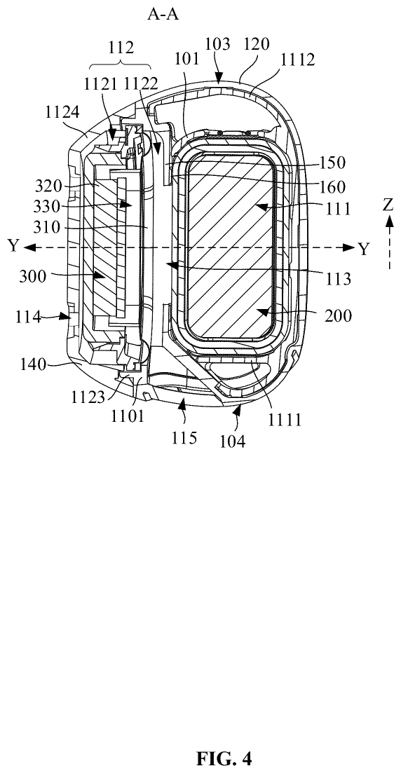

In some embodiments, as shown in FIG. 3a and FIG. 4, the housing assembly 100 may be provided with a sound outlet hole 114 and a pressure relief hole 115 through which the second accommodation cavity 112 is in flow communication with the external environment, and the sound outlet hole 114 and the pressure relief hole 115 may be spaced apart.

The air-conduction loudspeaker 300 is provided in the second accommodation cavity 112. The second accommodation cavity 112 may form a sound cavity space (an external acoustic sound cavity) of the air-conduction loudspeaker 300.

Providing the connecting hole 113 between the first accommodation cavity 111 and the second accommodation cavity 112 may cause the second accommodation cavity 112 to be in flow communication with the connecting hole 113. And since the bone-conduction loudspeaker 200 blocks the connecting hole 113 on a side of the connecting hole 113 opposite to the second accommodation cavity 112, the acoustic sound cavity may be widened into the connecting hole 113, thereby improving the volume of the acoustic sound cavity to improve the acoustic effect. The sound outlet hole 114 may be configured to guide sound waves generated by the air-conduction loudspeaker 300 out of the loudspeaker assembly 10 to propagate into the user's ear canal. Providing the pressure relief hole 115 through which the second accommodation cavity 112 is in communication with the external environment allows air to flow freely in the second accommodation cavity 112 and the air-conduction loudspeaker 300, preventing the air in the second accommodation cavity 112 from damping the vibration of the air-conduction loudspeaker 300 thereby affecting the sound quality of the air-conduction loudspeaker 300. Thus, the setting of the pressure relief hole 115 enables the headphone 1 to have a better sound quality effect.

Setting the sound outlet hole 114 and the pressure relief holes 115 spaced apart reduces the mutual interference between the sound outlet hole 114 and the pressure relief hole 115, so that the air pressure leaking out of the pressure relief holes 115 is less likely to affect the sound waves transmitted from the sound outlet hole 114, thus improving the sound quality effect of the headphone 1.

In some embodiments, as shown in FIG. 3a and FIG. 4, the pressure relief hole 115 is in flow communication with the second accommodation cavity 112, the connecting hole 113 is in flow communication with the second accommodation cavity 112, and the pressure relief hole 115 may be in flow communication with the connecting hole 113 through the second accommodation cavity 112.

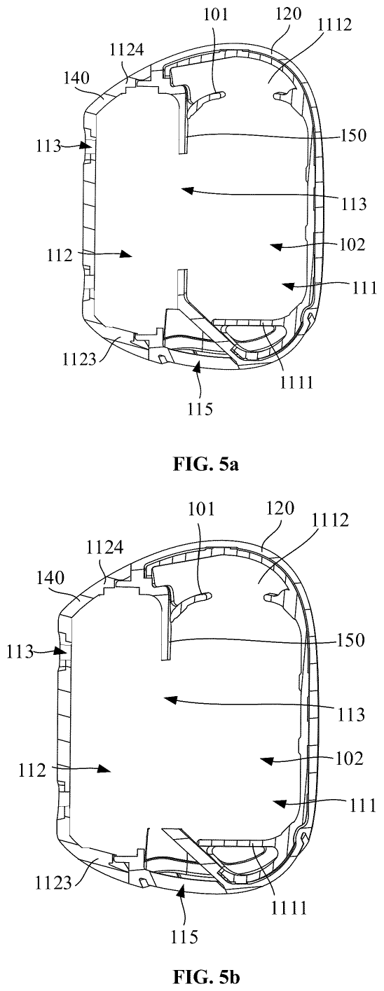

In another embodiment, as shown in FIG. 3b and FIG. 5b, the connecting hole 113 may be directly in flow communication with the pressure relief hole 115, and the bone-conduction loudspeaker 200 may block the connecting hole 113 on a side of the connecting hole 113 facing the first accommodation cavity 111, thereby ensuring the sealing performance of the first accommodation cavity 111. At the same time, the area of the inlet end of the pressure relief hole 115 can also be increased, which increases the effect of the pressure relief of the pressure relief hole 115, so as to improve the sound quality effect of the loudspeaker assembly 10.

In some embodiments, as shown in FIG. 3a and FIG. 4, the air-conduction loudspeaker 300 may be configured such that the second accommodation cavity 112 is divided into a first sub cavity 1121 and a second sub cavity 1122 isolated from each other. The first sub cavity 1121 and the second sub cavity 1122 are not in flow communication. The sound outlet hole 114 may be in flow communication with the first sub cavity 1121, and the pressure relief hole 115 may be in flow communication with the second sub cavity 1122. Further, the connecting hole 113 may be in flow communication with the second sub cavity 1122.

Optionally, as shown in FIG. 3a, the air-conduction loudspeaker 300 may include a diaphragm 310 and a driving mechanism 320, and the driving mechanism 320 may be connected to the diaphragm 310. An internal sound cavity 330 may be enclosed between the diaphragm 310 and the driving mechanism 320, and a side of the diaphragm 310 away from the internal sound cavity 330 is a sound cavity space, which is also referred to as the second sub cavity 1122. The driving mechanism 320 is configured to drive the diaphragm 310 to vibrate under the control of an electrical signal, thereby causing the air in the internal sound cavity 330 in the air-conduction loudspeaker 300 to vibrate to generate air-conduction sound waves, which may be propagated out of the loudspeaker assembly 10 through the first sub cavity 1121, the second sub cavity 1122 (i.e., the sound cavity space), and the sound outlet hole 114.

In this case, the volume of the second sub cavity 1122 may be increased due to the presence of the connecting hole 113, i.e., the volume of the sound cavity space may be increased, which in turn may enhance the sound quality effect of the loudspeaker assembly 10.

Specifically, when the headphone 1 is in operation, a portion of the sound waves generated by the air-conduction loudspeaker 300 utilizing an air vibration principle may be propagated out of the loudspeaker assembly 10 through the first sub cavity 1121 and the sound outlet hole 114. The pressure relief hole 115 may connect the second sub cavity 1122 with the external environment, allowing air to flow freely between the external environment and the second sub cavity 1122. If the second sub cavity 1122 is closed, the air in the second sub cavity 1122 produces air damping on the vibration of the air-conduction loudspeaker 300, which in turn may affect the sound quality of the air-conduction loudspeaker 300 when the air-conduction loudspeaker 300 is in operation. In such cases, the air pressure balance between the second sub cavity 1122 and the external environment may be maintained through the pressure relief hole 115 to reduce the effect on the sound produced by the air-conduction loudspeaker 300, thus reducing the effect on the sound quality of the headphone 1.

In some embodiments, there may be a plurality of pressure relief holes 115 spaced apart. The plurality of pressure relief holes 115 may enhance the pressure relief effect, which may improve the sound quality of the headphone 1. Optionally, at least two pressure relief holes 115 in flow communication with the external environment on the housing assembly 100 may be located on different side surfaces of the housing assembly 100, thereby reducing the probability of interference enhancement of the pressure relief holes 115.

In some embodiments, as shown in FIGS. 3a, 4, and 5a, the housing assembly 100 may include a first housing 120, a second housing 130, and a third housing 140. The second housing 130 may cooperate with the first housing 120 to form the first accommodation cavity 111 (schematically labeled on the first housing 120 in FIG. 4, but not implying that the first accommodation cavity 111 is only the portion shown on the first housing 120), and the third housing 140 may cooperate with the first housing 120 to form the second accommodation cavity 112 (schematically labeled in FIG. 4 on the first housing 120, but not implying that the second accommodation cavity 112 is only the portion shown on the first housing). The connecting hole 113 may be provided on the first housing 120. The third housing 140 may be provided with the sound outlet hole 114 through which the second accommodation cavity 112 is in flow communication with the external environment, and the first housing 120 may be provided with the pressure relief hole 115 through which the second accommodation cavity 112 is in flow communication with the external environment. Optionally, the pressure relief hole 115 may be provided on a side of the first housing 120 away from the third housing 140, which allows the pressure relief hole 115 to be far from the sound outlet hole 114.

The first housing 120, the second housing 130, and the third housing 140 are arranged to abut against each other to form the first accommodation cavity 111 as well as the second accommodation cavity 112, which facilitates assembling and disassembling the loudspeaker assembly 10 and improves the tightness and stability of the structure of the loudspeaker assembly 10. The sound outlet hole 114 is provided on the third housing 140, and the pressure relief hole 115 is provided on the first housing 120, thus a distance between the sound outlet hole 114 and the pressure relief hole 115 may be made larger, and the mutual interference between the sound waves transmitted by each of the sound output hole 114 and the pressure relief hole 115 may be reduced, thereby reducing the probability of the sound waves transmitted by the sound output hole 114 and the pressure relief hole 115 interfering with each other in the near field and enabling the headphone 1 to have a better sound quality effect.

As shown in FIG. 2, the headphone may include the wearing assembly 20 and the loudspeaker assembly 10 as described above. The wearing assembly 20 may also be referred to as the ear hook 20. Specifically, the wearing assembly 20 may be connected to the first housing 120. Connecting the wearing assembly 20 to the first housing 120 allows the wearing assembly 20 to be more tightly connected to the loudspeaker assembly 10 and less likely to detach from the loudspeaker assembly 10 during use. Optionally, the positions of the first housing 120 and the wearing assembly 20 correspond to the first accommodation cavity 111. Specifically, the wearing assembly 20 may point to the first accommodation cavity 111 when assembled on the first housing 120, such that when the first housing 120 swings relative to the wearing assembly 20, the swing position of the first housing 120 is closer to the first accommodation cavity 111, so that the first housing may swing more substantially and at a faster speed when the bone-conduction loudspeaker 200 vibrates the first housing 120, which improves the bone-conduction sound quality.

In some embodiments, as shown in FIG. 3a to FIG. 4, the housing assembly 100 may include a partition wall 150 for spacing apart the first accommodation cavity 111 and the second accommodation cavity 112. The connecting hole 113 may be provided on the partition wall 150. The bone-conduction loudspeaker 200 may block the connecting hole 113 on a side of the partition wall 150 facing the first accommodation cavity 111.

By using the partition wall 150 to separate the first accommodation cavity 111 and the second accommodation cavity 112 to further separate the bone-conduction loudspeaker 200 and the air-conduction loudspeaker 300, air vibrations generated by the bone-conduction loudspeaker 200 during vibration of the first accommodation cavity 111 may be prevented from partially eliminating air-conduction sound waves generated by the air-conduction loudspeaker 300, thereby preventing the bone-conduction loudspeaker 200 from affecting the transmission of air-conduction sound waves, and making it less likely that the bone-conduction loudspeaker 200 and the air-conduction loudspeaker 300 impact each other and cause mutual damage. The bone-conduction loudspeaker 200 and the air-conduction loudspeaker 300 may also be assembled more conveniently because the partition wall 150 separates the first accommodation cavity 111 and the second accommodation cavity 112. Furthermore, the bone-conduction loudspeaker 200 blocks the connecting hole 113 on the side of the partition wall 150 facing the first accommodation cavity 111, so that the connecting hole 113 is in flow communication with the second accommodation cavity 112 to form a larger volume space, thereby improving the sound quality of the air-conduction loudspeaker 300.

In some embodiments, as shown in FIG. 4, the bone-conduction loudspeaker 200 may be pressed against the partition wall 150 to seal the connecting hole 113. In other words, a wall surface of the bone-conduction loudspeaker 200 is directly or indirectly pressed against the partition wall 150 to seal the connecting hole 113, thereby ensuring that the first accommodation cavity 111 is airtight.

In other embodiments, a sealing member 160 may be provided between the bone-conduction loudspeaker 200 and the partition wall 150, with the sealing member 160 being provided around the connecting hole 113. One side of the sealing member 160 fits snugly against the partition wall 150 and around the connecting hole 113, and the other side may fit snugly against a wall of the bone-conduction loudspeaker 200, thereby allowing the bone-conduction loudspeaker 200 to seal the connecting hole 113. Providing the sealing member 160 between the bone-conduction loudspeaker 200 and the partition wall 150 may make the first accommodation cavity 111 more airtight, thus the bone-conduction effect is increased.

In some embodiments, the sealing member 160 may include at least one of sealant and a sealing rubber ring. If the sealing member 160 is a sealant, the sealant may be dispensed onto the partition wall 150 at the periphery of the connecting hole 113, and then the bone-conduction loudspeaker 200 may be pressed against the sealant as well as the partition wall 150, thereby sealing the connecting hole 113. The sealing rubber ring also has a good sealing performance, so providing the sealing rubber ring between the partition wall 150 and the bone-conduction loudspeaker 200 also improves the sealing performance of the first accommodation cavity 111. In other embodiments, the sealing member 160 may also be a gasket plate, a soft packing, or other components, which will not be specifically listed herein.

In some embodiments, as shown in FIG. 3a, FIG. 4, and FIG. 5a, the housing assembly 100 may be provided with a support wall 101 within the first accommodation cavity 111, the support wall 101 and the partition wall 150 jointly enclosing a limiting space 102. The bone-conduction loudspeaker 200 may be provided in the limiting space 102 and abut the support wall 101, and the support wall 101 and the partition wall 150 may be configured to cooperate to limit the movement of the bone-conduction loudspeaker 200 relative to the housing assembly 100 in a radial direction.

Specifically, the direction in which the bone-conduction loudspeaker 200 vibrates relative to the housing assembly 100 may be an axial direction of the bone-conduction loudspeaker 200, and the direction perpendicular to the axial direction of the bone-conduction loudspeaker 200 may be a radial direction of the bone-conduction loudspeaker 200. The support wall 101 and the partition wall 150 may be configured to cooperate to limit the movement of the bone-conduction loudspeaker 200 relative to the housing assembly 100 in any of the radial directions perpendicular to the axial direction. The axial direction of the bone-conduction loudspeaker 200 may be two directions extended by the X line in FIG. 3a, and the radial direction of the bone-conduction loudspeaker 200 may be two directions extended by the Y line in FIG. 3a and FIG. 4, but the radial direction is not limited to the direction specifically shown by the Y line.

Optionally, one end of the support wall 101 may be connected to the first housing 120 or the second housing 130, and the other end of the support wall 101 extends to the bone-conduction loudspeaker 200. The support wall 101 is adapted to an outer surface of the bone-conduction loudspeaker 200 to cause the support wall 101 to fit against the bone-conduction loudspeaker 200 in the radial direction of the bone-conduction loudspeaker 200, such that the support wall 101 and the partition wall 150 may cooperate to limit the movement of the bone-conduction loudspeaker 200 relative to the housing assembly 100 in the radial direction, thereby limiting the movement of the bone-conduction loudspeaker 200 in the axial direction of the bone-conduction loudspeaker 200, which may also make the internal structure of the loudspeaker assembly 10 more compact.

In some embodiments, as shown in FIG. 3a, the bone-conduction loudspeaker 200 may have a first central axis X and may be set up to generate vibrations in the direction of the first central axis X. The bone-conduction loudspeaker 200 may have a peripheral side surface 201 disposed around the first central axis X, the peripheral side surface 201 sealing the connecting hole 113. The two directions indicated by the first central axis X may also be the axial direction of the bone-conduction loudspeaker 200, and the bone-conduction loudspeaker 200 generates vibrations in the direction of the first central axis X and transmits the sound to the user through the bone-conduction vibrations.

Optionally, the peripheral side surface 201 of the bone-conduction loudspeaker 200 may abut against the support wall 101, and the support wall 101 and the partition wall 150 may act together on the peripheral side surface 201 of the bone-conduction loudspeaker 200 to limit the movement of the bone-conduction loudspeaker 200 relative to the housing assembly 100 in the radial direction.

In some embodiments, as shown in FIG. 3a and FIG. 4, the air-conduction loudspeaker 300 has a second central axis Y and is configured to vibrate in a direction of the second central axis Y.

Optionally, the first central axis X may be perpendicular to the second central axis Y, then the direction shown by the first central axis X may be the axial direction of the bone-conduction loudspeaker 200, and the direction shown by the second central axis Y may be the radial direction perpendicular to the axial direction of the bone-conduction loudspeaker 200.

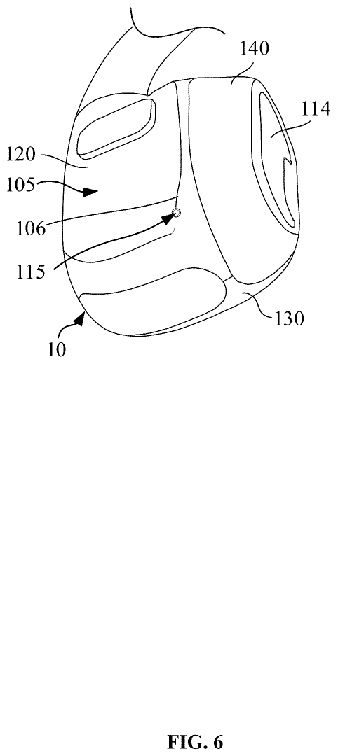

Optionally, as shown in FIG. 3a, FIG. 4, and FIG. 6, the housing assembly 100 may have a first side 103, a second side 104, and a third side 105. The first side 103 and the second side 104 are provided opposite each other in a direction perpendicular to the first central axis X and the second central axis Y, and the third side 105 is provided adjacent to the first side 103 and the second side 104. Optionally, the first central axis X or the second central axis Y may pass through the third side 105. A pressure relief hole 115 may be provided on the first side 103 or the second side 104, and another pressure relief hole 115 may be provided on the third side 105.

For example, in some embodiments, the first central axis X may pass through the third side 105. The housing assembly 100 has a face-fitting side for transmitting bone-conduction vibrations to the user's face, and the third side 105 is provided opposite to the face-fitting side. In other embodiments, the second central axis Y passes through the third side 105. The third side 105 is opposite to the sound outlet hole 114 on the housing assembly 100.

Providing a plurality of pressure relief holes 115 can increase the pressure relief area of the second accommodation cavity 112 for relieving pressure to the external environment, which makes air circulate rapidly between the external environment and the second accommodation cavity 112. Therefore, the air within the acoustic sound cavity in the second accommodation cavity 112 may be further rapidly exported to the external environment, reducing the damping of the air-conduction loudspeaker 300 due to the difficulty of the airflow, thus also avoiding the impact on the vibration sound waves of the air-conduction loudspeaker 300 because the second accommodation cavity 112 cannot release pressure after one of the pressure relief holes 115 has been blocked.

In some embodiments, different pressure relief holes 115 may be provided on different sides of the housing assembly 100. For example, by providing the pressure relief holes 115 on the first side 103 or the second side 104 and a position of the pressure relief hole 115 corresponding to the second sub cavity 1122, and on a position of the third side 105 corresponding to the second sub cavity 1122, the pressure relief holes 115 are in flow communication with the second sub cavity 1122. Such a setting may increase the pressure relief area while reducing the probability of interference between the sounds exported from each pressure relief hole 115, in particular the probability of constructive interference, improving the sound quality effect, and thus reducing the effect on the sound transmitted from the sound outlet holes 114.

In some embodiments, as shown in FIG. 6, the housing assembly 100 may be provided with an outwardly protruding body ridge line 106 on the third side 105, and another pressure relief hole 115 passes through the body ridge line 106 to be in flow communication with the external environment. Because the opening direction of the sound outlet hole 114 is usually toward the user's ear canal when the headphone 1 is worn, and a surface of the bone-conduction loudspeaker 200 for bone-conduction usually intimately contacts the skin next to the ear canal, the opening direction of the sound outlet 114 intersects with the bone-conduction surface to form an acute angle, and the housing assembly 100 may form the outwardly protruding body ridge line 106 on the side away from the skin of the human body.

Optionally, the body ridge line 106 may be located at a position on the first housing 120 corresponding to the second accommodation cavity 112 such that the pressure relief hole 115 located on the body ridge line 106 is in flow communication with the second accommodation cavity 112. By providing the other pressure relief hole 115 on the body ridge line 106, the pressure relief hole 115 may not be easily covered when the headphone 1 is worn, thereby ensuring air circulation in the pressure relief hole 115. In other embodiments, the body ridge line 106 of the third side 105 may be recessed toward the interior of the housing assembly 100.

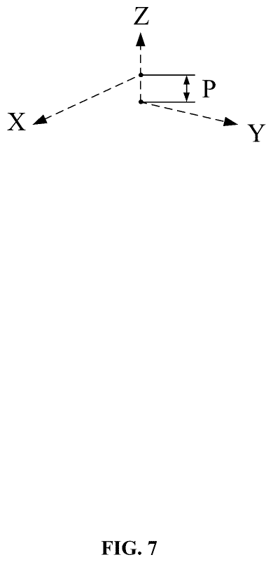

In some embodiments, as shown in FIG. 4, FIG. 5a, and FIG. 7, in a vertical direction Z of the first central axis X and the second central axis Y, the first accommodation cavity 111 may have a first bottom wall 1111 and a second bottom wall 1112 opposite to the first bottom wall 1111, and the second accommodation cavity 112 may have a third bottom wall 1123 and a fourth bottom wall 1124 opposite to the third bottom wall 1123. The first bottom wall 1111 and the third bottom wall 1123 may be provided adjacent to each other, the vertical direction Z has a positive direction from the first bottom wall 1111 toward the second bottom wall 1112 and a reverse direction opposite to the positive direction. The positive direction is shown as the Z arrow in FIG. 3a and FIG. 7.

Optionally, the peripheral side surface 201 of the bone-conduction loudspeaker 200 may abut against the first bottom wall 1111, and the first bottom wall 1111, the support wall 101, and the partition wall 150 cooperate to enclose the limiting space 102. The bone-conduction loudspeaker 200 may be provided in the limiting space 102 and abut against the support wall 101 and the first bottom wall 1111.

In the positive direction, the lowest position of the first bottom wall 1111 may be higher than the lowest position of the third bottom wall 1123.

In some embodiments, as shown in FIG. 4, the housing assembly 100 has a wall portion 1101 adjacent to the first accommodation cavity 111 in the vertical direction, and the pressure relief hole 115 is provided on the wall portion 1101.

Specifically, by providing the pressure relief hole 115 on the wall portion 1101 between the first bottom wall 1111 and the third bottom wall 1123, the space within the housing assembly 100 may be fully utilized to improve the space utilization of the loudspeaker assembly 10. By placing the lowest position of the first bottom wall 1111 higher than the lowest position of the third bottom wall 1123, the first bottom wall 1111 and the third bottom wall 1123 may be staggered in the positive direction of the vertical direction Z, and the wall portion 1101 between the two can have a larger space to set the pressure relief hole 115, thus the size of the pressure relief hole 115 may be set larger to improve the pressure relief effect.

In some embodiments, as shown in FIG. 4 to FIG. 5a, the pressure relief hole 115 may extend from the second accommodation space 110 to the outside of the housing assembly 100 on the wall portion 1101 and have a flared shape, and a portion of the hole wall of the pressure relief hole 115 close to the third bottom wall 1123 gradually tilts toward the third bottom wall 1123 in the opposite direction. Such a setting may further increase the size of the pressure relief hole 115, which facilitates the pressure relief of the pressure relief hole 115 and enhances the sound quality of the loudspeaker assembly 10.

In some embodiments, as shown in FIG. 3a and FIG. 7, the first central axis X and the second central axis Y may be skew lines, and in the vertical direction Z of the first central axis X and the second central axis Y, the first central axis X and the second central axis Y are staggered from each other.

The bone-conduction loudspeaker 200 vibrates in the direction of the first central axis X, and the air-conduction loudspeaker 300 vibrates in the direction of the second central axis Y, by setting the first central axis X and the second central axis Y to be skew lines and staggered with each other, the mutual interference between the bone-conduction loudspeaker 200 and the air-conduction loudspeaker 300 when they are vibrating may be reduced, thereby improving the effect of the bone-conduction loudspeaker 200 and the air-conduction loudspeaker 300 generating and conducting sound.

For example, in some embodiments, as shown in FIG. 7, the first central axis X may be set higher than the second central axis Y in the positive direction, which facilitates setting the lowest position of the first bottom wall 1111 higher than the lowest position of the third bottom wall 1123, thereby facilitating the formation of the pressure relief hole 115 of a flared shape to set the size of the flared pressure relief holes 115 larger.

In some embodiments, as shown in FIG. 7, a distance P between the first central axis X and the second central axis Y may be within a range of 0.2-0.8 mm. The distance between the first central axis X and the second central axis Y may be shown as the distance P in FIG. 5a. For example, the distance P between the first central axis X and the second central axis Y may be 0.3, 0.5, or 0.7.

Optionally, the first central axis X is higher than the second central axis Y in the positive direction. By setting the distance between the first central axis X and the second central axis Y in this manner, the size of the loudspeaker assembly 10 may be reduced while enabling the lowest position of the first bottom wall 1111 to be higher than the lowest position of the third bottom wall 1123.

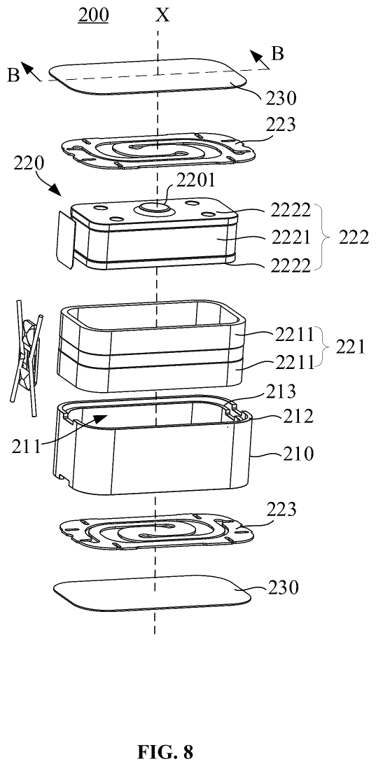

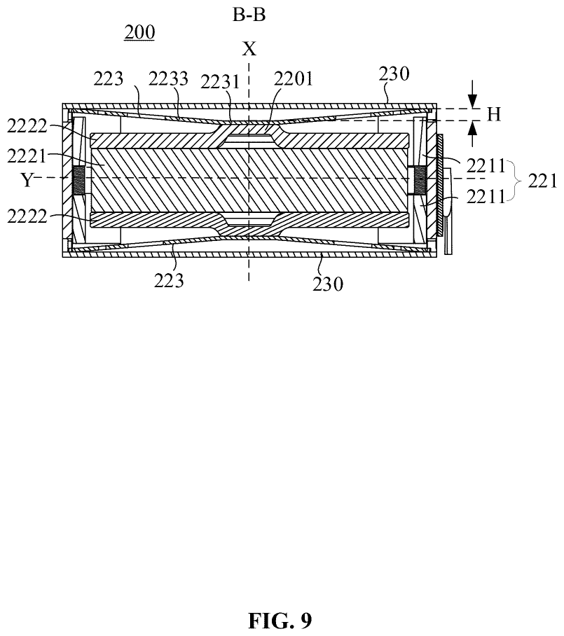

In some embodiments, as shown in FIG. 8 and FIG. 9, the bone-conduction loudspeaker 200 may include a cylindrical housing 210, a voice coil assembly 221, a magnet assembly 222, and a vibration transmission plate 223 that are provided along the first central axis X. The voice coil assembly 221 and the magnet assembly 222 may be provided in a cylindrical space of the cylindrical housing 210, the vibration transmission plate 223 may be fixedly connected to one of the magnet assembly 222 and the voice coil assembly 221, and the cylindrical housing 210, and the other of the magnet assembly 222 and the voice coil assembly 221 is fixedly connected to the cylindrical housing 210. The cylindrical housing 210 seals the connecting hole 113.

The magnet assembly 222 is configured to vibrate the voice coil assembly 221 by interacting the magnetic field with the voice coil assembly 221 when current passes through the voice coil assembly 221, thereby converting sound-related current signals into vibration signals. The voice coil assembly 221 is configured to generate an electrical signal to interact with the magnetic field of the magnet assembly 222 when current passes through the voice coil assembly 221, thereby causing the magnet assembly 222 to vibrate. The cylindrical housing 210 may be a magnetically conductive cover configured to constrain the direction of the magnetic field of the magnet assembly 222. The cylindrical housing 210 may also be configured to contact the housing assembly 100, and when the voice coil assembly 221 vibrates, the voice coil assembly 221 may drive the cylindrical housing 210 to vibrate to transmit the vibration signal to the housing assembly 100 through the cylindrical housing 210. The vibration transmission plate 223 is configured to elastically connect the voice coil assembly 221 and the magnet assembly 222 to elastically constrain the voice coil assembly 221 and the magnet assembly 222 to move relative to each other along the direction of the first central axis X.

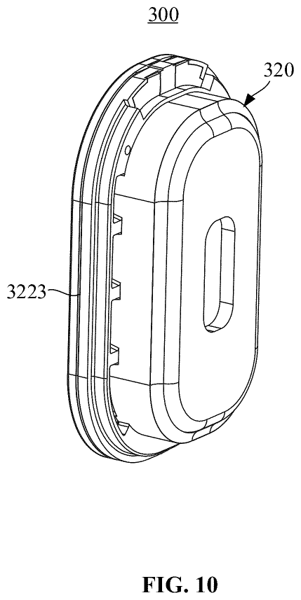

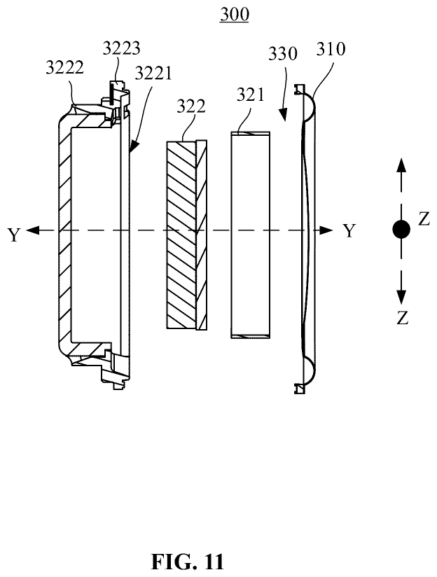

In some embodiments, as shown in FIG. 10-FIG. 11, the air-conduction loudspeaker 300 may include a diaphragm 310 and a driving mechanism 320, the driving mechanism 320 may be connected to the diaphragm 310, and an internal sound cavity 330 may be enclosed between the diaphragm 310 and the driving mechanism. The driving mechanism 320 is configured to drive the diaphragm 310 to vibrate under the control of the electrical signal, so as to cause the air in the internal sound cavity 330 in the air-conduction loudspeaker 300 to vibrate to generate sound waves.

The air-conduction loudspeaker 300 may be arranged within the second accommodation cavity 112 in various manners. For example, the internal sound cavity 330 may be in flow communication with the second sub cavity 1122 to be in flow communication with the pressure relief hole 115, or the internal sound cavity 330 may be in flow communication with the first sub cavity 1121. The following are two ways of arranging the air-conduction loudspeaker 300.

First, the diaphragm 310 may be closer to the connecting hole 113 than the driving mechanism 320, the diaphragm 310 is provided opposite to the connecting hole 113 and faces the second sub cavity 1122, and the first sub cavity 1121 may be in flow communication with the internal sound cavity 330.

When the driving mechanism 320 drives the diaphragm 310 to generate vibration, the diaphragm 310 is closer to the connecting hole 113, i.e., closer to the bone-conduction loudspeaker 200. On the one hand, since the radial size of the diaphragm 310 is larger and the radial size of the driving mechanism 320 is smaller, providing the diaphragm 310 with a larger radial size close to the bone-conduction loudspeaker 200 and providing the driving mechanism 320 with a smaller radial size close to the outer side may effectively reduce the volume of the housing assembly 100 close to the outer side and make the volume and size of the loudspeaker assembly 10 more compact and reasonable, and improve the utilization rate of the internal space of the loudspeaker assembly 10. On the other hand, the diaphragm 310 is provided opposite to the connecting hole 113 and faces the second sub cavity 1122, which may effectively increase the volume of the second sub cavity 1122, and the air inside the second sub cavity 1122 is effectively conducted out through the pressure relief hole 115, thereby improving the pressure relief effect.

Second, the diaphragm 310 may be located farther away from the connecting hole 113 than the driving mechanism 320, the diaphragm 310 may be away from the connecting hole 113 and face the first sub cavity 1121, and the second sub cavity 1122 is in flow communication with the internal sound cavity 330.

By providing the diaphragm 310 away from the connecting hole 113 and facing the first sub cavity 1121, the sound waves generated by the diaphragm 310 can be easily transmitted to the first sub cavity 1121. Due to the connecting hole 113 and the second sub cavity 1122, which is equivalent to enlarging the internal sound cavity 330 and relieving the pressure through the pressure relief hole 115, the pressure relief effect may be effectively improved.

In some embodiments, as shown in FIG. 10 to FIG. 11, the driving mechanism 320 may include a voice coil 321 and a magnetic circuit assembly 322. The magnetic circuit assembly 322 includes a housing body 3222 having an open end 3221 and an annular flange 3223 provided at the open end 3221 of the housing body 3222 and protruding from an outer peripheral surface of the housing body 3222. The magnetic circuit assembly 322 is configured to interact with the voice coil 321 to generate vibration, and the voice coil 321 is configured to interact with the magnetic field of the magnetic circuit assembly 322 to drive the magnetic circuit assembly 322 to generate vibration when a current passes through the voice coil 321.

Wherein, an edge of the diaphragm 310 may be secured to the annular flange 3223. The voice coil 321 may be connected to a side of the diaphragm 310 facing the magnetic circuit assembly 322. The internal sound cavity 330 may be formed between the diaphragm 310 and the magnetic circuit assembly 322, and the diaphragm 310 may be located on a side of the housing body 3222 away from the sound outlet hole 114 and face the connecting hole 113, with the first sub cavity 1121 in flow communication with the internal sound cavity 330. Providing the first sub cavity 1121 in flow communication with the internal sound cavity 330 allows sound waves generated by vibration of the air inside the internal sound cavity 330 to propagate out of the loudspeaker assembly 10 through the first sub cavity 1121 and the sound outlet hole 114.

Optionally, the annular flange 3223 and the diaphragm 310 may be provided on the side away from the sound outlet hole 114, thus the diaphragm 310 and the annular flange 3223, etc., may be closer to the interior of the housing assembly 100, thereby enabling the diaphragm 310 of the air-conduction loudspeaker 300 to have a larger radial size and the annular flange 3223 to be provided away from the sound outlet hole 114, and the smaller-sized portion of the air-conduction loudspeaker 300 may be close to the sound outlet hole 114. Compared with the conventional speaker whose diaphragm 310 must face the sound outlet hole 114, the reversely arranged structure of the air-conduction loudspeaker 300 may effectively reduce the size of the portion of the housing assembly 100 close to the sound outlet hole 114, so that the size may be reduced from the middle region of the housing assembly 100 to a portion of the sound outlet hole 114 (i.e. the radial size of the outer peripheral surface of the housing assembly 100 may be gradually reduced). Then, the structure may be more compact, thereby effectively improving the space utilization rate of the housing assembly 100 and reducing the overall volume of the entire housing assembly 100. In addition, the reversely arranged structure optimizes the sound path, which in turn improves sound quality. In short, reversing the air-conduction loudspeaker 300 along the direction of air-conduction vibration effectively reduces the structural size of the housing assembly 100.

In the loudspeaker assembly 10, if the sound outlet hole 114 and the pressure relief hole 115 are located relatively close to each other, the sound waves generated by the pressure relief hole 115 may interact with the sound waves generated by the sound outlet hole 114, and the sound waves may interfere in the near field. The low-frequency sound waves transmitted by the sound outlet hole 114 are easily weakened by the inverse interference of the sound waves transmitted by the pressure relief hole 115, thereby generating an acoustic cancellation phenomenon. The technical means related to the pressure relief hole 115 and the sound outlet hole 114 are further described in the following embodiments.

The following is an exemplary description of headphone 1 of another embodiment.

As mentioned above, the housing assembly 100 may be provided with an accommodation space 110. The air-conduction loudspeaker 300 and the bone-conduction loudspeaker 200 are provided within the accommodation space 110.

Optionally, the bone-conduction loudspeaker 200 has a first central axis X and generates vibrations in the direction of the first central axis X. The air-conduction loudspeaker 300 has a second central axis Y and generates vibrations in the direction of the second central axis Y. Specifically, the voice coil and the diaphragm of the air-conduction loudspeaker 300 generate vibrations in the direction of the second central axis Y.

The housing assembly 100 is further provided with a sound outlet hole 114 and a pressure relief hole 115 that are in flow communication with the accommodation space 110, the sound outlet hole 114 and the pressure relief hole 115 being configured to conduct a portion of the sound waves generated by the air-conduction loudspeaker 300 to the external environment, respectively. The pressure relief hole 115 and the sound outlet hole 114 may be located on two opposite side surfaces of the housing assembly 100, respectively.

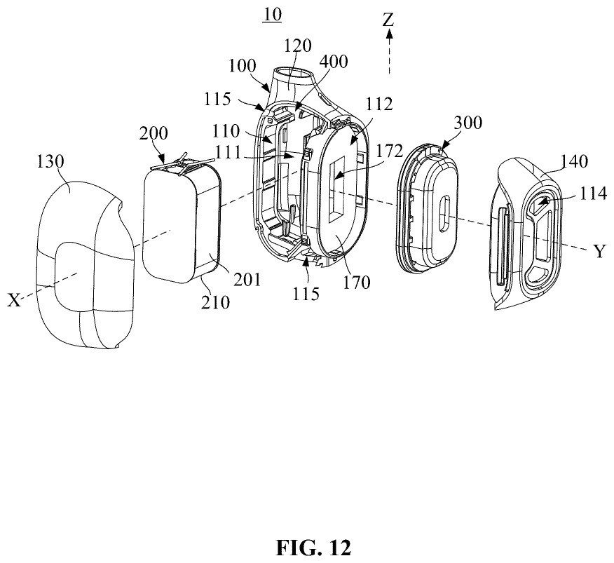

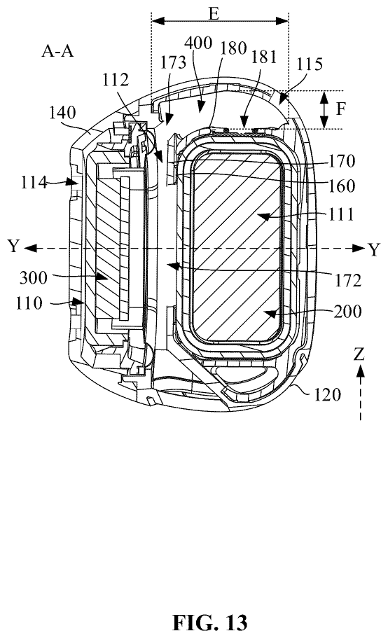

As shown in FIG. 12 to FIG. 13, the housing assembly 100 may include a first housing 120, a second housing 130, and a third housing 140. The first housing 120, the second housing 130, and the third housing 140 may cooperate to enclose an accommodation space 110. Optionally, the second housing 130 may be connected to the first housing 120 in the direction of the first central axis X, and the third housing 140 may be connected to the second housing 130 in the direction of the second central axis Y. Optionally, the sound outlet hole 114 may be provided on the third housing 140, and the pressure relief hole 115 may be provided on a portion of the first housing 120 that is away from the third housing 140 such that the sound outlet hole 114 and the pressure relief hole 115 are located on two opposite side surfaces of the housing assembly 100, respectively.

By providing the sound outlet hole 114 and the pressure relief hole 115 on two opposite side surfaces of the housing assembly 100, the distance between the sound outlet hole 114 and the pressure relief hole 115 can be increased compared to arranging the sound outlet hole 114 and the pressure relief hole 115 on adjacent side surfaces or the same side surface of the housing assembly 100, so as to reduce the mutual influence of the sound outlet hole 114 and the pressure relief hole 115, reduce the interference cancellation between the sound outlet hole 114 and the pressure relief hole 115 in the near field (which weakens the sound wave transmitted by the sound outlet hole 114), thereby weakening the sound cancellation phenomenon between the sound outlet hole 114 and the pressure relief hole 115 and improving the low-frequency effect of the loudspeaker assembly 10, thus improving the sound quality effect of the headphone 1.

In some embodiments, the loudspeaker assembly 10 may be provided with a pressure relief channel 400 in flow communication with the pressure relief hole 115, as illustrated in FIGS. 12 to 13. The sound outlet hole 114 may be in flow communication with the accommodation space 110, and the pressure relief channel 400 is configured to guide a portion of sound waves generated by the air-conduction loudspeaker 300 within the accommodation space 110 to the pressure relief hole 115.

By providing the pressure relief channel 400 through which the accommodation space 110 is in flow communication with the pressure relief hole 115, the air that needs pressure relief in the accommodation space 110 can be conveniently guided to the pressure relief channel 400 and further realize pressure relief through the pressure relief hole 115. On the one hand, the pressure relief path is extended to improve the pressure relief effect, and on the other hand, the pressure relief channel 400 is in flow communication with the pressure relief hole 115, which may make the sound waves that need pressure relief not easily affect the work of other components during the pressure relief process, thereby improving the sound quality effect of the loudspeaker assembly 10. The setting of the pressure relief channel 400 may also realize precise positioning of the pressure relief of the air-conduction loudspeaker 300, and reduce the mutual influence between the sound outlet hole 114 and the pressure relief hole 115 while improving the flexibility of the pressure relief of the air-conduction loudspeaker 300.

In some embodiments, the pressure relief channel 400 and the accommodation space 110 may be spaced apart from each other, and the pressure relief channel 400 may be in flow communication with the accommodation space 110. Optionally, the first housing 120 may be provided with the pressure relief channel 400 as described above, with one end of the pressure relief channel 400 being in flow communication with the accommodation space 110, and with the other end of the pressure relief channel 400 being formed as a pressure relief hole 115. Specifically, the pressure relief channel 400 and the accommodation space 110 may be spaced apart from each other so that the air may be relieved independently of the other components in the accommodation space 110 and spaced apart from the other components in the accommodation space 110, so as to not easily affect the components in the accommodation space 110. Furthermore, by providing the first housing 120 with the pressure relief channel 400, on the one hand, the distance between the pressure relief hole 115 and the sound outlet hole 114 may be larger, and on the other hand, the first housing 120, the second housing 130, and the third housing 140 are assembled without the need to additionally assemble the pressure relief channel 400, thereby improving assembly efficiency.

In some embodiments, as shown in FIG. 12 to FIG. 13, the accommodation space 110 may include a first accommodation cavity 111 and a second accommodation cavity 112 separated from each other. The bone-conduction loudspeaker 200 is provided in the first accommodation cavity 111, and the air-conduction loudspeaker 300 is provided in the second accommodation cavity 112. The sound outlet hole 114 is in flow communication with the second accommodation cavity 112, the pressure relief channel 400 is in flow communication with the second accommodation cavity 112 and spaced from the first accommodation cavity 111, and the pressure relief channel 400 is in flow communication with the second accommodation cavity 112 and the pressure relief hole 115.

Optionally, the second housing 130 and the first housing 120 are cooperatively connected to form the first accommodation cavity 111, and the third housing 140 and the first housing 120 are cooperatively connected to form the second accommodation cavity 112.

Because the bone-conduction loudspeaker 200 and the air-conduction loudspeaker 300 have different working principles, the first accommodation cavity 111 is spaced apart from the second accommodation cavity 112 and the pressure relief channel 400 to ensure that the bone-conduction loudspeaker 200 operates independently, which not only minimizes the impact of the air-conduction loudspeaker 300 on the bone-conduction loudspeaker 200 but also provides a certain degree of protection for the bone-conduction loudspeaker 200. When the headphone 1 is in operation, as the sound waves generated by the air vibration principle of the air-conduction loudspeaker 300 may be transmitted out of the loudspeaker assembly 10 through the sound outlet hole 114 to be transmitted to the user's ear canal, connecting the second accommodation cavity 112 in which the air-conduction loudspeaker 300 is located to the external environment through the pressure relief hole 115 may allow air to flow freely in the second accommodation cavity 112 and the air-conduction loudspeaker 300, preventing the air in the second accommodation cavity 112 from damping the vibration of the air-conduction loudspeaker 300 and affecting the sound quality effect produced by the air-conduction loudspeaker 300.

In some embodiments, the first accommodation cavity 111 and the second accommodation cavity 112 may be isolated from each other. Specifically, the area of the first accommodation cavity 111 in flow communication with the external environment may be smaller than the area of the second accommodation cavity 112 in flow communication with the external environment and the area of the pressure relief channel 400 in flow communication with the external environment. In other words, the sealing performance of the first accommodation cavity 111 is better than the sealing performance of the second accommodation cavity 112 and the sealing performance of the pressure relief channel 400. The sealing performance may be understood as the airtightness of the cavity space.

Because the bone-conduction loudspeaker 200 requires a highly sealed environment to ensure the bone-conduction effect, the bone-conduction loudspeaker 200 and the air-conduction loudspeaker 300 are independently provided in two different cavities in the accommodating space 110 to effectively reduce the mutual interference between the bone-conduction loudspeaker 200 and the air-conduction loudspeaker 300. Additionally, placing the bone-conduction loudspeaker 200 in the first accommodation cavity 111 with a better sealing performance may also effectively improve the sound quality effect produced by the bone-conduction loudspeaker 200.

Optionally, the pressure relief channel 400 and the first accommodation cavity 111 are spaced apart in the vertical direction Z of the arrangement direction of the first accommodation cavity 111 and the second accommodation cavity 112. As shown in FIG. 12 to FIG. 13, the arrangement direction of the first accommodation cavity 111 and the second accommodation cavity 112 may be the same as the direction of the second central axis Y of the air-conduction loudspeaker 300, and may be the direction shown by the Y line in FIG. 12 and FIG. 13. The vertical direction Z of the arrangement direction of the first accommodation cavity 111 and the second accommodation cavity 112 is shown by the Z arrow in FIG. 12 and FIG. 13.

Optionally, a length component of the extended length of the pressure relief channel 400 along the arrangement direction is greater than a length component of the extended length along the vertical direction Z. In such cases, the pressure relief channel 400 may occupy a smaller size in the vertical direction Z, thereby reducing the size of the loudspeaker assembly 10 in the vertical direction Z, while making the distance between the sound outlet hole 114 and the pressure relief hole 115 larger to reduce the influence between the sound outlet hole 114 and the pressure relief hole 115 in the near field. The length component of the extended length of the pressure relief channel 400 along the arrangement direction is shown as the length E in FIG. 13, and the length component of the pressure relief channel 400 in the vertical direction Z is shown as the length F in FIG. 13 shown in FIG. 13, where length E is larger than length F.

In some embodiments, as shown in FIG. 12 to FIG. 13, the housing assembly 100 may be provided with a first partition wall 170 between the first accommodation cavity 111 and the second accommodation cavity 112 and a second partition wall 180 between the pressure relief channel 400 and the second accommodation cavity 112. The first partition wall 170 may separate the second accommodation cavity 112 and the first accommodation cavity 111. The second partition wall 180 may be configured to separate the pressure relief channel 400 and the first accommodation cavity 111. In this way, independent pressure relief channel 400 and first accommodation cavity 111 may be formed. On the one hand, the pressure relief channel 400 may extend the pressure relief path, increase the size of the pressure relief space, and enhance the effect of the pressure relief, which may improve the sound quality. On the other hand, the working processes of the air-conduction loudspeaker 300 and the bone-conduction loudspeaker 200 may not interfere with each other, reducing the mutual influence between the air-conduction loudspeaker 300 and the bone-conduction loudspeaker 200 and ensuring the sound quality output effects of the air-conduction loudspeaker 300 and the bone-conduction loudspeaker 200.

Optionally, one end of the second partition wall 180 is connected to the first housing 120, and the other end of the second partition wall 180 is connected to the first partition wall 170 such that the pressure relief channel 400 and the first accommodation cavity 111 can be arranged at intervals in the vertical direction Z.

Optionally, as shown in FIG. 13, the first partition wall 170 may further extend between the second accommodation cavity 112 and the pressure relief channel 400, and the first partition wall 170 may be provided with a sound guide hole 173 through which the second accommodation cavity 112 is in flow communication with the pressure relief channel 400. The pressure relief hole 115 is in flow communication with the second accommodation cavity 112 via the pressure relief channel 400 and the sound guide hole 173. When the headphone 1 is in operation, a portion of the sound waves generated by the air-conduction loudspeaker 300 that need pressure relief may be transmitted out of the loudspeaker assembly 10 through the second accommodation cavity 112, the sound guide hole 173, the pressure relief channel 400, and the pressure relief hole 115 in sequence, thereby preventing the air in the second accommodation cavity 112 from damping the vibration of the air-conduction loudspeaker 300 and affecting the sound quality effect produced by the air-conduction loudspeaker 300.

In some embodiments, as shown in FIG. 13, the housing assembly 100 may be provided with a first connecting hole 172 between the first accommodation cavity 111 and the second accommodation cavity 112, the first accommodation cavity 111 is in flow communication with the second accommodation cavity 112 through the first connecting hole 172. The bone-conduction loudspeaker 200 may seal the first connecting hole 172 to allow the first accommodation cavity 111 and the second accommodation cavity 112 to be isolated from each other.

The first connecting hole 172 is provided between the first accommodation cavity 111 and the second accommodation cavity 112, and the bone-conduction loudspeaker 200 is configured to seal the first connecting hole 172 on one side of the first connecting hole 172, so that the strong sealing performance of the second accommodation cavity 112 may be ensured while expanding the space for use of the first accommodation cavity 111. The convenience of the assembly of the air-conduction loudspeaker 300 and the reliability of the structural setup may be effectively improved, and the volume of the sound cavity space formed by the air-conduction loudspeaker 300 in the second accommodation cavity 112 may be simply and effectively expanded, which may enhance the sound effect of the air-conduction loudspeaker 300 and improve the sound quality of the air-conduction loudspeaker 300. In other words, the air-conduction loudspeaker 300 may be set closer to the bone-conduction loudspeaker 200 while keeping the volume of the sound cavity space unchanged, which may reduce the size of the loudspeaker assembly 10 and realize the compactness of the overall size.

In some embodiments, as shown in FIG. 13, the housing assembly 100 may be provided with a second connecting hole 181 between the first accommodation cavity 111 and the pressure relief channel 400, the first accommodation cavity 111 is in flow communication with the pressure relief channel 400 through the second connecting hole 181, and the bone-conduction loudspeaker 200 seals the second connecting hole 181 so that the first accommodation cavity 111 and the pressure relief channel 400 are isolated from each other.

Similarly, providing the second connecting hole 181 through which the first accommodation cavity 111 is in flow communication with the pressure relief channel 400, and providing the bone-conduction loudspeaker 200 to seal the second connecting hole 181, may increase the area of the pressure relief channel 400 while ensuring a strong sealing performance of the first accommodation cavity 111, thereby allowing the pressure relief channel 400 to have a larger space for pressure relief, thereby improving the pressure relief effect, or may make the pressure relief channel 400 closer to the first accommodation cavity 111 while ensuring the size of the area, thereby reducing the size of the loudspeaker assembly 10 in the vertical direction Z.

In other embodiments, the pressure relief channel 400 may be provided in other forms. Other forms of the pressure relief channel 400 are exemplary described below.

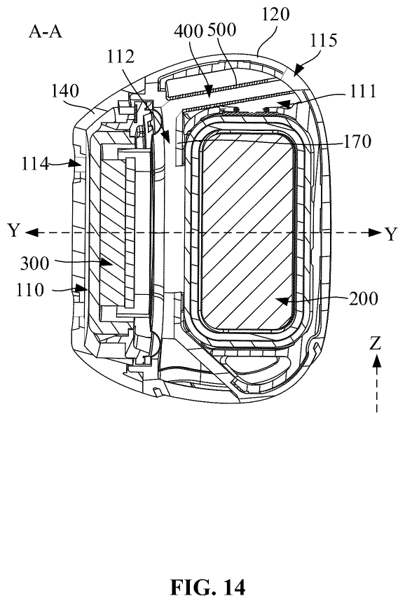

In some embodiments, as shown in FIG. 14, the loudspeaker assembly 10 includes a channel tube 500 formed with a pressure relief channel 400, the channel tube 500 being fixedly provided on the housing assembly 100 and located in the first accommodation cavity 111. One end of the channel tube 500 is connected to the second accommodation cavity 112, and the other end is connected to the pressure relief hole 115.

Optionally, a first partition wall 170 may be provided between the first accommodation cavity 111 and the second accommodation cavity 112, and the first partition wall 170 may separate the second accommodation cavity 112 and the first accommodation cavity 111. One end of the channel tube 500 may be connected to the first partition wall 170 to be in flow communication with the second accommodation cavity 112, and the other end may be in flow communication with the pressure relief hole 115 on the first housing 120, such that the second accommodation cavity 112 is in flow communication with the external environment.

Optionally, the bone-conduction loudspeaker 200 may be spaced apart from the channel tube 500 in the vertical direction Z.

The channel tube 500 is provided within the first accommodation cavity 111 and is isolated from the first accommodation cavity 111 and not in flow communication with the first accommodation cavity 111. Specifically, the portion of the channel tube 500 that is in flow communication with the second accommodation cavity 112 is sealed with respect to the first accommodation cavity 111, and the portion of the channel tube 500 that is in flow communication with the pressure relief hole 115 is also sealed with respect to the first accommodation cavity 111. Specifically, the channel tube 500 is sealed and connected to the first housing 120 within the first accommodation cavity 111, and thus not in flow communication with the first accommodation cavity 111, which ensures a strong sealing performance of the first accommodation cavity 111, thereby ensuring the bone-conduction effect of the bone-conduction loudspeaker 200.

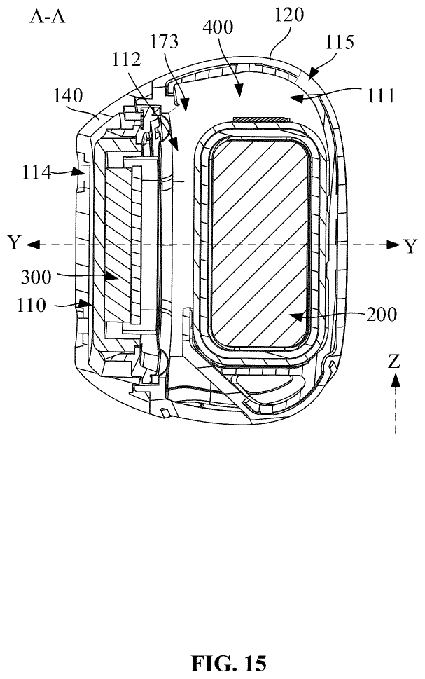

In other embodiments, as shown in FIG. 15, a portion of the accommodation space 110 may be formed as a pressure relief channel 400.

Optionally, the bone-conduction loudspeaker 200 may be provided as a sealed structure, the interior of which is isolated from the accommodation space 110. The pressure relief channel 400 may be formed between the bone-conduction loudspeaker 200 and the inner wall of the accommodation space 110. Because the bone-conduction loudspeaker 200 is a sealed structure, the bone-conduction loudspeaker 200 may avoid as much as possible the influence of the water vapor of the accommodation space 110, which also makes the bone-conduction loudspeaker 300 adaptable to a non-sealed environment and produces a better bone-conduction effect without a strong sealing performance.

Optionally, as shown in FIG. 15, the accommodation space 110 may include a first accommodation cavity 111 and a second accommodation cavity 112 spaced apart from each other, and the bone-conduction loudspeaker 200 may be provided in the first accommodation cavity 111 and may form a pressure relief channel 400 with the inner wall of the first accommodation cavity 111. The air-conduction loudspeaker 300 may be provided in the second accommodation cavity 112. The housing assembly 100 is provided with a sound guide hole 173 between the first accommodation cavity 111 and the second accommodation cavity 112, and the first accommodation cavity 111 is in flow communication with the second accommodation cavity 112 through the sound guide hole 173.

Specifically, the pressure relief hole 115 is provided on the first housing 120 and is in flow communication with the first accommodation cavity 111. Then the sound waves generated by the air-conduction loudspeaker 300 that need pressure relief may be transmitted out of the loudspeaker assembly 10 through the second accommodation cavity 112, the sound guide hole 173, the first accommodation cavity 111 (i.e., the pressure relief channel 400), and the pressure relief hole 115 in sequence.

In such cases, the pressure relief channel 400 is formed between the bone-conduction loudspeaker 200 and the inner wall of the first accommodation cavity 111, which may simplify the internal structure of the first accommodation cavity 111, reduce the size of the first accommodation cavity 111, and thus make the structure of the loudspeaker assembly 10 more compact. In addition, by using the first accommodation cavity 111 and the bone-conduction loudspeaker 200 to form the pressure relief channel, the space utilization rate of the first accommodation cavity 111 can be improved, which may make full use of the space of the first accommodation cavity 111 to increase the size of the pressure relief channel 400, improve the effect of the pressure relief, and thus improve the sound quality effect of the air-conduction loudspeaker 300.

In some embodiments, as shown in FIG. 8 to FIG. 9, the bone-conduction loudspeaker 200 may include a cylindrical housing 210, a drive assembly 220, and two sealing plates 230. The cylindrical housing 210 may be fixedly connected to the housing assembly 100, the drive assembly 220 is provided within the cylindrical housing 210, and the drive assembly 220 is configured to drive the cylindrical housing 210 to vibrate, thereby driving the housing assembly 100 to vibrate. Two sealing plates 230 may be provided at two ends of the cylindrical housing 210 and configured to seal the cylindrical housing 210 to form the sealed structure.

Optionally, the drive assembly 220 is provided between the two sealing plates 230, and the drive assembly 220 and the two sealing plates 230 are arranged in sequence in the direction of the first central axis X. The drive assembly 220 is configured to, under the action of the electric current signal, vibrate in the direction of the first central axis X to drive the cylindrical housing 210 and the housing assembly 100 to vibrate, thereby transmitting the vibration signal to the human body that is affixed to the body of the housing assembly 100 to realize the function of bone-conduction.

By providing two sealing plates 230 to seal the cylindrical housing 210, the sealed structure of the bone-conduction loudspeaker 200 is realized, the interference of water vapor and dust from the outside world on the bone-conduction loudspeaker 200 is reduced, and the structure of the bone-conduction loudspeaker 200 is more integrated, thereby improving the compactness of the structure. Optionally, the sealing plates 230 may be provided as magnetically conductive sheet plates, which suppress the magnetic leakage of the drive assembly 220, thereby enhancing the magnetic field strength within the cylindrical housing 210.

In some embodiments, the bone-conduction loudspeaker 200 may also include a vibration transmission plate 223, as shown in FIG. 8 to FIG. 9. The drive assembly 220 may further include a voice coil assembly 221 and a magnet assembly 222, the voice coil assembly 221 may be sleeved on the magnet assembly 222, the vibration transmission plate 223 may be fixedly connected between the cylindrical housing 210 and one of the voice coil assembly 221 and the magnet assembly 222, and the other one of the voice coil assembly 221 and the magnet assembly 222 may be fixedly connected to the cylindrical housing 210.

The magnet assembly 222 is configured to make its magnetic field interact with the voice coil assembly 221 when current passes through the voice coil assembly 221, thereby generating a vibration to convert a sound-related current signal into a vibration signal. The voice coil assembly 221 is configured to generate an electrical signal to interact with the magnetic field of the magnet assembly 222 when current passes through the voice coil assembly 221, thereby generating vibration. The cylindrical housing 210 is configured to constrain the direction of the magnetic field of the magnet assembly 222, and the cylindrical housing 210 is also configured to be in contact with the housing assembly 100. When the voice coil assembly 221 vibrates, the voice coil assembly 221 may drive the cylindrical housing 210 to vibrate and then transmit the vibration signal to the housing assembly 100 through the cylindrical housing 210. The vibration transmission plate 223 is configured to elastically connect the voice coil assembly 221 and the magnet assembly 222 to elastically constrain the voice coil assembly 221 and the magnet assembly 222 to move relative to each other in the direction of the first central axis X.

The following embodiments further exemplify describe the sealing structure of the bone-conduction loudspeaker 200.

Referring to FIG. 3a, the bone-conduction loudspeaker 200 is provided within the accommodation space 110. The bone-conduction loudspeaker 200 is connected to the housing assembly 100. Specifically, when the headphone 1 is in use, the housing assembly 100 may fit the user's human body, and the bone-conduction loudspeaker 200 is configured to drive the housing assembly 100 to vibrate by bone-conduction vibration so as to conduct sound to the user.

In some embodiments, as illustrated in FIG. 8 to FIG. 9, the bone-conduction loudspeaker 200 may include a cylindrical housing 210, a drive assembly 220, and two sealing plates 230. The cylindrical housing 210 may enclose an accommodation space 211. The drive assembly 220 may be provided in the accommodation space 211 and connected to the cylindrical housing 210. The two sealing plates 230 may be provided at two ends of the cylindrical housing 210 and seal the accommodation space 211.

The drive assembly 220 may be configured to convert the current signal into a vibration signal to enable the drive assembly 220 to vibrate to drive the cylindrical housing 210 when the bone-conduction loudspeaker 200 is used. The two sealing plates 230 are used to seal two ends of the cylindrical housing 210 so that the accommodation space 211 where the drive assembly 220 is located forms a closed space, thereby restricting the drive assembly 220, and thus preventing the drive assembly 220 from falling out of the cylindrical housing 210. Additionally, the use of the two sealing plates 230 for sealing the cylindrical housing 210 also prevents impurities such as dust and water droplets from entering the accommodation space 211 and affecting the vibration of the drive assembly 220, thereby ensuring the bone-conduction effect of the bone-conduction loudspeaker 200, extending the service life of the bone-conduction loudspeaker 200, making the structure of the bone-conduction loudspeaker 200 more integrated, and improving the compactness of the structure.

Optionally, the sealing plates 230 may be provided as magnetically conductive sheet plates, which suppress magnetic leakage of the drive assembly 220 to enhance the magnetic field strength within the cylindrical housing 210. For example, the sealing plates 230 may be steel plates. In some embodiments, the sealing plates 230 may also be plain metal plates.

In some embodiments, as shown in FIG. 8 to FIG. 9, the bone-conduction loudspeaker 200 may further include a vibration transmission plate 223, the vibration transmission plate 223 connecting the drive assembly 220 to the cylindrical housing 210. In the direction of the central axis of the cylindrical housing 210, the vibration transmission plate 223 may be provided between the drive assembly 220 and the sealing plates 230 and is provided opposite to the sealing plates 230. Specifically, the central axis of the cylindrical housing 210 may coincide with the first central axis X of the bone-conduction loudspeaker 200, and the direction of the central axis of the cylindrical housing 210 is shown by the X-arrow in FIG. 8 and FIG. 9.

The vibration transmission plate 223 is configured to connect the drive assembly 220 to limit the drive assembly 220, and the drive assembly 220 drives the cylindrical housing 210 to vibrate by driving the vibration transmission plate 223 during vibration. Specifically, the sealing plates 230, the vibration transmission plate 223, and the drive assembly 220 are sequentially arranged in the direction of the central axis of the cylindrical housing 210. The vibration direction of the bone-conduction loudspeaker 200 may also be in the direction of the central axis of the cylindrical housing 210, i.e., the vibration direction of the drive assembly 220 is also in the direction of the central axis of the cylindrical housing 210. In such cases, the sealing plates 230 and the vibration transmission plate 223 may double limit the drive assembly 220 directly in the vibration direction of the drive assembly 220 when the drive assembly 220 vibrates during operation, and the sealing plates 230 may also limit the vibration transmission plate 223, thereby preventing excessive deformation of the vibration transmission plate 223 during the vibration of the drive assembly 220, improving the service life of the vibration transmission plate 223.

In some embodiments, as shown in FIG. 8 to FIG. 9, two sealing plates 230 may be fixedly connected to the two ends of the cylindrical housing 210, and a periphery of the vibration transmission plate 223 is fixed to an inner wall of the cylindrical housing 210.

Optionally, as shown in FIG. 8 to FIG. 9, at least one end of the cylindrical housing 210 may have a stepped shape to form a first support surface 212 and a second support surface 213 having a stepped drop in the direction of the central axis, and the second support surface 213 may be closer to the central axis of the cylindrical housing 210 than the first support surface 212. The sealing plate 230 is fixedly supported on the first support surface 212. The periphery of the vibration transmission plate 223 is fixedly supported on the second support surface 213.

Optionally, the first support surface 212 may be flush with a surface of the vibration transmission plate 223 away from the second support surface 213, such that when the sealing plate 230 is fixedly supported on the first support surface 212, the vibration transmission plate 223 can be pressed on the second support surface 213 to further fix the vibration transmission plate 223 to the cylindrical housing 210. Such an arrangement can make the structure of the bone-conduction loudspeaker 200 more compact and also facilitate assembly and installation.

The connection between one sealing plate 230 and the first support surface 212 may be sealed (for example, a sealant may be applied for fixing and sealing, or fixing and sealing by welding), and the other sealing plate 230 provided at the other end of the cylindrical housing 210 may also be sealed with the cylindrical housing 210, so as to make the cylindrical housing 210 present a sealed structure.

In other embodiments, the vibration transmission plate 223 may be fixedly connected to one end of the cylindrical housing 210. The sealing plates 230 are fixedly stacked on a side of the vibration transmission plate 223 away from the drive assembly 220 and spaced from the cylindrical housing 210.

Specifically, the sealing plate 230, the vibration transmission plate 223, and the cylindrical housing 210 are sequentially stacked in the axial direction of the cylindrical housing 210, the periphery of the vibration transmission plate 223 is fixedly connected to an end surface of the cylindrical housing 210, and the sealing plates 230 are fixed to the vibration transmission plate 223 and thereby connected to the cylindrical housing 210 through the vibration transmission plate 223. The connection between the vibration transmission plate 223 and the cylindrical housing 210, and the connection between the sealing plates 230 and the vibration transmission plate 223 are both sealed.

In other embodiments, the vibration transmission plate 223 and the sealing plates 230 may be fixed relative to the cylindrical housing 210 in other ways. For example, the periphery of the vibration transmission plate 223 may be directly connected to the inner wall of the cylindrical housing 210, and the sealing plate 230 is fixedly supported on the first support surface 212 to cover one end of the first support surface 212, which is not specifically listed in this embodiment.

In some embodiments, as shown in FIG. 8 to FIG. 9, there are two vibration transmission plate 223, the two vibration transmission plates 223 may be fixedly connected to the cylindrical housing 210, respectively, and the two sealing plates 230 may be respectively provided on one side of the two vibration transmission plates 223 away from the drive assembly 220.

Specifically, the two vibration transmission plates 223 and the two sealing plates 230 may be sequentially arranged in the direction of the central axis of the cylindrical housing 210. In addition, the two vibration transmission plates 223 and the two sealing plates 230 may be located at two sides of the drive assembly 220, respectively, and the two vibration transmission plates 223 connect the drive assembly 220 to the cylindrical housing 210 on the two sides of the drive assembly 220 to limit the drive assembly 220 on the two sides of the drive assembly 220. The two sealing plates 230 may be respectively provided on one side of the two vibration transmission plates 223 away from the drive assembly 220, to protect the two vibration transmission plates 223 and seal the accommodation space 211 of the cylindrical housing 210.

Setting the two vibration transmission plates 223 facilitates the drive assembly 220 to drive the cylindrical housing 210 to vibrate by driving the two vibration transmission plates 223 during the vibration process, so as to improve the bone-conduction effect of the bone-conduction loudspeaker 300 and thus improve the sensitivity of the bone-conduction loudspeaker 300. Limiting the drive assembly 220 may also share the pressure caused by the vibration of the drive assembly 220, thereby improving the service life of the vibration transmission plates 223 and improving the service life of the bone-conduction loudspeaker 200.

In other embodiments, the count of the vibration transmission plate 223 may be one, which may be provided on one side of the cylindrical housing 210 and connected to the drive assembly 220, thereby limiting the drive assembly 220. The two sealing plates 230 may likewise be provided on two sides of the cylindrical housing 210 and seal the accommodation space 211 of the cylindrical housing 210, and the vibration transmission plate 223 may be located between the two sealing plates 230 to be disposed in the accommodation space 211 of the cylindrical housing 210. Optionally, the sealing plate 230 on the side away from the vibration transmission plate 223 may be integrally molded with the cylindrical housing 210 to form a one-piece structure, which improves the sealing performance of the accommodation space 211.

In some embodiments, as shown in FIG. 8 to FIG. 9, the drive assembly 220 may further include a voice coil assembly 221 and a magnet assembly 222. The first one of the voice coil assembly 221 and the magnet assembly 222 is provided around the second one of the voice coil assembly 221 and the magnet assembly 222, and the first one of the voice coil assembly 221 and the magnet assembly 222 is fixedly connected to the cylindrical housing 210. The vibration transmission plate 223 fixedly connects the second one of the voice coil assembly 221 and the magnet assembly 222 and the cylindrical housing 210. The vibration transmission plate 223 and the sealing plate 230 are provided opposite to each other in the direction of the central axis, and the vibration transmission plate 223 is configured to elastically constrain the voice coil assembly 221 and the magnet assembly 222 to move relative to each other in the direction of the central axis of the cylindrical housing 210. The voice coil assembly 221 is configured to receive an electric current that forms a current loop through the voice coil assembly 221, the magnet assembly 222 is configured to interact with the electric current in the voice coil assembly 221 to generate vibrations in the direction of the central axis, and the magnet assembly 222 may directly or indirectly drive the cylindrical housing 210 to move when vibrating. The magnet assembly 222 and the voice coil assembly 221 move relative to each other in the direction of the central axis of the cylindrical housing 210.

For example, in the embodiments shown in FIG. 8 and FIG. 9, the first one of the voice coil assembly 221 and the magnet assembly 222 may be the voice coil assembly 221, and the second one of the voice coil assembly 221 and the magnet assembly 222 may be the magnet assembly 222. Specifically, the voice coil assembly 221 is provided on the inner wall of the cylindrical housing 210 and is fixedly connected to the cylindrical housing 210, the voice coil assembly 221 is provided around the magnet assembly 222, the magnet assembly 222 is provided in the accommodation space 211 of the cylindrical housing 210 and is spaced apart from the voice coil assembly 221, and the vibration transmission plate 223 is fixedly connected to the magnet assembly 222 and the cylindrical housing 210. The magnet assembly 222, the vibration transmission plate 223, and the sealing plates 230 are sequentially arranged along the direction of the central axis of the cylindrical housing 210. When the magnet assembly 222 interacts with the voice coil assembly 221, the magnet assembly 222 drives the cylindrical housing 210 to vibrate through the vibration transmission plate 223.

In other embodiments, the first one of the voice coil assembly 221 and the magnet assembly 222 may be the magnet assembly 222, and the second one of the voice coil assembly 221 and the magnet assembly 222 may be the voice coil assembly 221. Specifically, the magnet assembly 222 may be fixedly affixed to the inner wall of the cylindrical housing 210, the magnet assembly 222 is provided around the voice coil assembly 221, and the voice coil assembly 221 is connected to the cylindrical housing 210 via the vibration transmission plate 223. The magnet assembly 222 interacts with the voice coil assembly 221, and the magnet assembly 222 may directly drive the cylindrical housing 210 to generate a vibration, and then the cylindrical housing 210 drives the housing assembly 100 to generate a vibration.

Setting the vibration transmission plate 223 to elastically constrain the voice coil assembly 221 and the magnet assembly 222 to move relative to each other may cause the magnet assembly 222 to be consistently encircled by the voice coil assembly 221, so as to maintain the interaction between the magnetic field of the magnet assembly 222 and the current of the voice coil assembly 221, thereby maintaining the vibration of the magnet assembly 222, such that the bone-conduction loudspeaker 200 can realize the bone-conduction function for a long period of time.

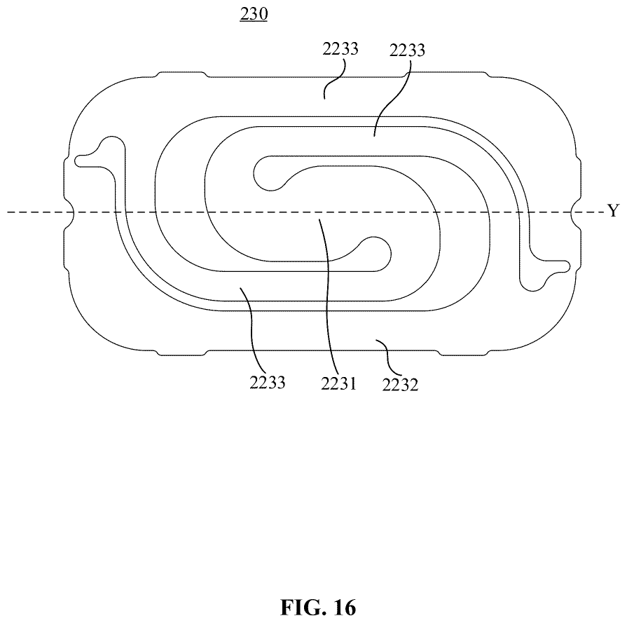

In some embodiments, as shown in FIG. 16, the vibration transmission plate 223 may be located between the second one of the voice coil assembly 221 and the magnet assembly 222, and a corresponding sealing plate 230. The sealing plate 230 is configured to rigidly constrain, along the direction of the central axis, a magnitude of deformation of the vibration transmission plate 223 to rigidly constrain the magnitude of deformation of the vibration transmission plate 223, thereby rigidly constraining the relative movement range of the voice coil assembly 221 and the magnet assembly 222.

Specifically, in the process of interaction between the voice coil assembly 221 and the magnet assembly 222, the second one of the voice coil assembly 221 and the magnet assembly 222 affects the vibration transmission plate 223 and causes the vibration transmission plate 223 to undergo elastic deformation. Therefore, the sealing plate 230 is provided on the side of the vibration transmission plate 223 that is away from the voice coil assembly 221 and the magnet assembly 222 to rigidly constrain the amplitude of the deformation of the vibration transmission plate 223, so as to prevent the vibration transmission plate 223 from undergoing a deformation that exceeds its elasticity limit during the process of being driven to produce a deformation that results in the transition from elastic deformation to plastic deformation of the vibration transmission plate 223, thereby protecting the vibration transmission plate 223.

The position of the sealing plate 230 may be determined according to the relative movement range of the voice coil assembly 221 and the magnet assembly 222 and the elastic limit of the vibration transmission plate 223, so that the sealing plate 230 may constrain the relative movement range of the voice coil assembly 221 and the magnet assembly 222, thereby enabling the sealing plate 230 and the vibration transmission plate 223 to jointly constrain the relative movement range of the voice coil assembly 221 and the magnet assembly 222 to a maximum relative movement range. Therefore, the vibration transmission plate 223, the voice coil assembly 221, and the magnet assembly 222 are protected, and the vibration effect of the bone-conduction loudspeaker 200 is improved.

In some embodiments, as shown in FIG. 8 and FIG. 16, the vibration transmission plate 223 may include a center fixing portion 2231, an annular fixing portion 2232 surrounding the periphery of the center fixing portion 2231, and a linkage assembly 2233 connected between the center fixing portion 2231 and the annular fixing portion 2232. The annular fixing portion 2232 is connected to the cylindrical housing 210, and the center fixing portion 2231 is connected to the second one of the voice coil assembly 221 and the magnet assembly 222.

The linkage assembly 2233 can undergo elastic deformation to elastically constrain the second one of the voice coil assembly 221 and the magnet assembly 222 when the current passes through the voice coil assembly 221. The elastic constraint may be understood as that the second one of the voice coil assembly 221 and the magnet assembly 222 can move within the relative motion range allowed by the elastic deformation of the linkage assembly 2233. The linkage assembly 2233 may, on the one hand, limit the relative movement range between the voice coil assembly 221 and the magnet assembly 222 along the direction of the central axis, and on the other hand, also reset the voice coil assembly 221 and the magnet assembly 222 by elastic recovery after the voice coil assembly 221 and the magnet assembly 222 have achieved relative movement.

The vibration transmission plate 223 has an excellent elastic deformation capability due to the setting of the linkage assembly 2233. A sealed space may not be created with the cylindrical housing 210 since the vibration transmission plate 223 is also connected to the interior of the cylindrical housing 210, but a sealed space may be formed with the cylindrical housing 210 by sealing the hollow on the vibration transmission plate 233 using the sealing plates 230. This setup can enhance the performance of the magnetic circuit of the bone-conduction loudspeaker 10 and improve the sound quality effect.

In the natural state, the center fixing portion 2231 and the corresponding sealing plate 230 have a spacing in the direction of the central axis. The natural state refers to when the current does not pass through the voice coil assembly 221, i.e., when the voice coil assembly 221 is stationary relative to the magnet assembly 222. When the voice coil assembly 221 and the magnet assembly 222 are relatively stationary, a spacing is provided between the center fixing portion 2231 and the corresponding sealing plate 230 in the direction of the central axis, so that the second one of the voice coil assembly 221 and the magnet assembly 222 may have a space for vibration relative to the cylindrical housing 210 in the direction of the central axis, so that bone-conduction sound may be transmitted to the user's body in the direction of the central axis through the cylindrical housing 210 and the housing assembly 100.

Optionally, in the natural state, the center fixing portion 2231 is closer to the second one of the voice coil assembly 221 and the magnet assembly 222 than the annular fixing portion 2232 in the direction of the central axis. In the natural state, the vibration transmission plate 223 may have a certain pre-deformation, i.e., the linkage assembly 2233 of the vibration transmission plate 223 has a certain degree of pre-deformation, thereby ensuring that in the natural state, the two vibration transmission plates 223 acts on two sides of the magnet assembly 222 to ensure that the magnet assembly 222 is in the middle position of the cylindrical housing 210, and making the vibration of the magnet assembly 222 more stable in the vibration process.

In the embodiments of the present disclosure, the sealing plates 230 may be flat plates, concave plates with a middle position concave inwardly toward the magnet assembly 222 with respect to an edge position, or convex plates with a middle position convex outwardly away from the magnet assembly 222 with respect to an edge position.

In some embodiments, a distance between the center fixing portion 2231 and the corresponding sealing plate 230 is within a range of 0.005-0.8 mm.

Defining a distance between the center fixing portion 2231 and the corresponding sealing plate 230 may enable the drive assembly 220 to drive the center fixing portion 2231 to vibrate within this distance, thereby driving the cylindrical housing 210 to vibrate.

Optionally, the distance between the center fixing portion 2231 and the corresponding sealing plate 230 may be a distance between a center point of the center fixing portion 2231 and a center point of the sealing plate 230. As shown in FIG. 9, the distance between the center fixing portion 2231 and the corresponding sealing plate 230 is shown as distance H in the figure. For example, the distance between the center point of the center fixing portion 2231 and the center point of the sealing plate 230 may be 0.2 mm, 0.5 mm, or 0.7 mm. By setting the distance between the center fixing portion 2231 and the corresponding sealing plate 230 in this manner, the sealing plate 230 can limit the vibration of the center fixing portion 2231 and the drive assembly 220, preventing the vibration amplitude of the drive assembly 220 from being too large to make the deformation of the linkage assembly 2233 f exceed its tolerance range and be damaged.

As shown in FIG. 8 and FIG. 9, the magnet assembly 222 may further include a magnet 2221 and two magnetic conductive plates 2222, the two magnetic conductive plates 2222 being provided on two side surfaces of the magnet 2221 away from each other along the direction of the central axis. The magnetic conductive plate 2222 has a protruding portion 2201 protruding toward the center fixing portion 2231, and the protruding portion 2201 is fixedly connected to the center fixing portion 2231.

The magnetic conductive plates 2222 are configured to constrain the direction of the magnetic field of the magnet 2221 on two end surfaces of the magnet 2221, wherein the two end surfaces are on two sides of the magnet 2221 that are arranged opposite to each other along the direction of the central axis, so as to enhance the effect of the interaction between the magnet 2221 and a voice coil 2211.

The two protruding portions 2201 of the two magnetic conductive plates 2222 protrude respectively toward the center fixing portions 2231 of the two vibration transmission plates 223 corresponding to the two magnetic conductive plates 2222, i.e., the directions of the two protruding portions 2201 are opposite. By setting the protruding portions 2201 to be fixedly connected to the center fixing portions 2231, respectively, the two magnetic conductive plates 2222 and the two vibration transmission plates 223 may be in a more stable fixed connection, and the connection parts between the magnetic conductive plates 2222 and the vibration transmission plates 223 may not excessively occupy the space of the linkage assembly 2233, so that the linkage assembly 2233 has a sufficiently large region to generate elastic deformation, thus providing sufficient deformation space to make the vibration transmission plates 223 have better elasticity.

In some embodiments, as shown in FIG. 8 and FIG. 9, the voice coil assembly 221 may further include two voice coils 2211 spaced apart in a direction of the central axis, with the cylindrical housing 210 wound around the periphery of the two voice coils 2211. Projections of the two magnetic conductive plates 2222 along the radial direction of the bone-conduction loudspeaker 200 respectively at least partially overlap the two voice coils 2211, and the energizing directions of the two voice coils 2211 are opposite.

The radial direction of the bone-conduction loudspeaker 200 is as shown by the Y arrow in FIG. 9. Setting the projections of the two magnetic conductive plates 2222 along the radial direction of the bone-conduction loudspeaker 200 respectively at least partially overlapping the two voice coils 2211 may enhance the interaction between the two magnetic conductive plates 2222, the magnet 2221, and the two voice coils 2211, making the magnet assembly 222 more sensitive. The energizing directions of the two voice coils 2211 are opposite to ensure that the two voice coils 2211 are subjected to the same direction of force under the interaction of the same magnet 2221, so that the magnet 2221 may move in one direction under the action of the two voice coils 2211 and the magnetic field, and the magnet 2221 may vibrate in the direction of the central axis by changing the current direction of the two voice coils 2211.

In some embodiments, the accommodation space 211 is filled with a magnetic fluid, the magnetic fluid occupying at least a portion of the accommodation space 211.

The magnetic fluid is also referred to as a magnetic liquid, a ferromagnetic fluid, or a ferrofluid, the magnetic fluid has the fluidity of a liquid and the magnetism of a solid magnetic material, and the magnetic fluid has a better magnetic permeability compared to air, which increases the magnetic field effect of the magnet assembly 222, making the vibration of the magnet assembly 222 more sensitive. Additionally, the magnetic fluid also reduces the resistance of the relative movement between the voice coil assembly 221 and the magnet assembly 222, which improves the vibration effect, effectively improving the sound quality, thus improving the bone-conduction effect of the bone-conduction loudspeaker 200 and improving the sound quality effect of the loudspeaker assembly 10.

Optionally, the magnetic fluid may not fully fill the accommodation space 211 to reduce fluid resistance and improve the bone-conduction effect of the bone-conduction loudspeaker 200.

In some embodiments, the air-conduction loudspeaker 300 and the housing assembly 100 become vibration loads because the bone-conduction loudspeaker 200 drives the housing assembly 100 when it vibrates in the axis of the bone-conduction loudspeaker 200. In the related art, the air-conduction loudspeaker 300 is usually provided next to the axis of the bone-conduction loudspeaker 200 (e.g., the air-conduction loudspeaker 300 is provided in the radial direction of the bone-conduction loudspeaker 200 perpendicular to the axis), in which case the mass of the air-conduction loudspeaker 300 biases the vibration of the bone-conduction loudspeaker 200, causing the loudspeaker assembly 10 to generate two torques in different directions, attenuating the bone-conduction vibration of the loudspeaker 200 in the axial direction, reducing the volume of the bone-conduction component of the headphone 1.

In order to solve the above problem, the following embodiment exemplarily describes the position, structure, or the like of the bone-conduction loudspeaker 200 and the air-conduction loudspeaker 300 of the loudspeaker assembly 10.

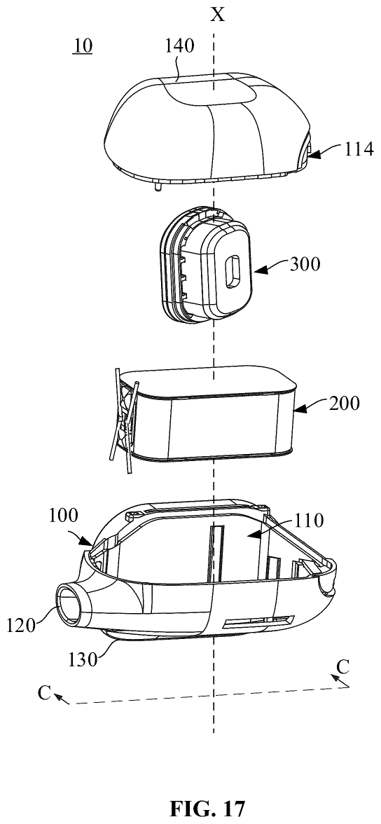

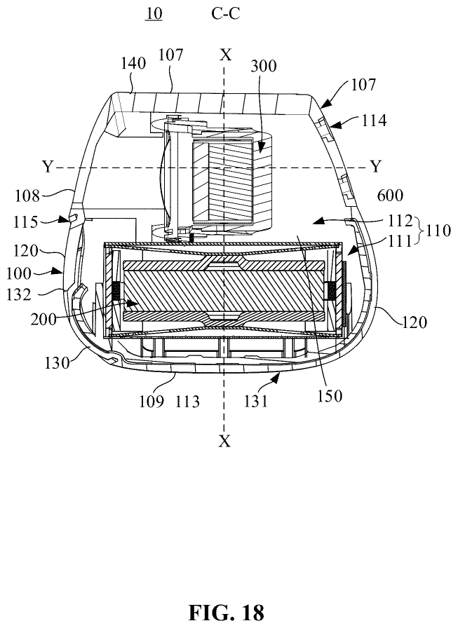

As shown in FIG. 17 and FIG. 18, the bone-conduction core module 200 and the air-conduction core module 300 are provided within the housing assembly 100 as previously described. The bone-conduction core module 200, which may also be referred to as a bone-conduction loudspeaker 200, is configured to transmit sound to the user by bone-conduction vibration. The air-conduction core module 300, which may be referred to as an air-conduction loudspeaker 300, is configured to transmit sound to the ear canal of the user by air-conduction vibration.

Optionally, the housing assembly 100 may be provided with an accommodation space 110. The bone-conduction core module 200 is provided in the accommodation space 110 and generates vibration in the first vibration direction. The air-conduction core module 300 is provided in the accommodation space 110. The air-conduction core module 300 and the bone-conduction core module 200 are arranged in the first vibration direction and face each other. Specifically, the air-conduction core module 300 and the bone-conduction core module 200 face each other means that, in a reference plane perpendicular to the first vibration direction, a projection of the air-conduction core module 300 has an overlapping region with a projection of the bone-conduction core module 200.

The first vibration direction of the bone-conduction core module 200 may be consistent with the direction of the central axis of the bone-conduction core module 200, which is shown as the arrow X in FIG. 18.

Providing the air-conduction core module 300 in the first vibration direction of the bone-conduction core module 200 allows the mass of the air-conduction core module 300 to be more centered on the axis of the bone-conduction core module 200, and the biasing effect of the air-conduction core module 300 on the vibration of the bone-conduction core module 200 along the first vibration direction is weakened. Thus, the bone-conduction core module 200 may better drive the housing assembly 100 to vibrate in the first vibration direction, and the sound quality generated by the vibration of the bone-conduction core module 200 is more pure, which is in accordance with the principles of acoustic design. Reducing the influence of the mass of the air-conduction core module 300 on the vibration effect of the bone-conduction core module 200 may make the bone-conduction core module 200 have a better bone-conduction effect and improve the sound quality effect of the bone-conduction component of the headphone 1.

In some embodiments, the air-conduction core module 300 may vibrate in the second vibration direction. An angle between the first vibration direction and the second vibration direction is within a range of 70°-100° or 80°-90°.

Providing the first vibration direction and the second vibration direction different and crossing each other reduces mutual interference between the air-conduction core module 300 and the bone-conduction core module 200, so that the air-conduction core module 300 has a better sound output effect and the bone-conduction core module 200 has a good bone-conduction effect.

The angle between the first vibration direction and the second vibration direction may be 75°, 85°, or 95°. For example, optionally, the first vibration direction and the second vibration direction may be perpendicular to each other, i.e., the angle between the first vibration direction and the second vibration direction may be 90°. The second vibration direction may be the axial direction of the air-conduction core module 300, and the second vibration direction may be shown by the Y arrow in FIG. 18.

Such a setting may greatly reduce the mutual influence between the air-conduction core module 300 and the bone-conduction core module 200, so that the vibration of each may be less likely to be affected by the vibration of the other, which may improve the sound quality of the headphone 1.

In some embodiments, as shown in FIGS. 17 to 18, the housing assembly 100 may be provided with a first side surface 107, a second side surface 108, and a vibration transmitting surface 109 (i.e., the face-fitting side mentioned above), the first side surface 107, the second side surface 108, and the vibration transmitting surface 109 may be non-coplanar, and the first side surface 107 and the second side surface 108 are spaced apart in a direction perpendicular to the first vibration direction. The housing assembly 100 may be provided with a sound outlet hole 114 penetrating the first side surface 107 and in flow communication with the accommodation space 110, and a pressure relief hole 115 penetrating the second side surface 108 and in flow communication with the accommodation space 110.

The sound outlet hole 114 and the pressure relief hole 115 are configured to conduct at least a portion of the sound waves generated by the air-conduction core module 300 to the external environment, respectively. The sound outlet hole 114 is usually provided facing or close to the user's ears, to conduct a portion of the sound waves generated by the air-conduction core module 300 to the user's ears, and the pressure relief hole 115 is configured to release air in the accommodation space 110 that damps the vibration of the air-conduction loudspeaker 300, so that the accommodation space 110 achieves air pressure balance to reduce the effect on the vibration effect of the air-conduction core module 300.

Providing the sound outlet hole 114 and the pressure relief hole 115 at the oppositely disposed first side surface 107 and second side surface 108, respectively, may relatively increase the distance between the sound output hole 114 and the pressure relief hole 115, thereby reducing the portion of the sound waves released by the pressure relief hole 115 and the sound waves conducted by the sound outlet hole 114 to interact with each other, in particular to interfere with cancellation, thereby improving the quality of the sound conducted by the sound outlet hole 114. In other embodiments, the positions of the sound outlet hole 114 and the pressure relief hole 115 on the housing assembly 100 may be swapped to adapt to the specific position of the human ear.

Optionally, the vibration transmitting surface 109 may be perpendicular to the first vibration direction, and the bone-conduction core module 200 transmits vibrations outwardly through the vibration transmitting surface 109. Such a setting may make the pressure relief hole 115, the sound outlet hole 114, and the vibration transmitting surface 109 all non-coplanar, which may make the sound waves transmitted by the sound outlet hole 114, the sound waves released by the pressure relief hole 115, and the vibrations on the vibration transmission surface 109 are not easy to interfere with each other, so that the sound outlet hole 114 and the pressure relief hole 115 may improve the sound quality of the loudspeaker assembly 10.

In some embodiments, as shown in FIG. 18, the air-conduction core module 300 may be stacked on the bone-conduction core module 200 along the first vibration direction. In other words, the air-conduction core module 300 and the bone-conduction core module 200 are stacked along the first vibration direction. Optionally, the air-conduction core module 300 is fixedly connected to the bone-conduction core module 200.

Fixing the air-conduction core module 300 to the bone-conduction core module 200 along the first vibration direction can facilitate the bone-conduction core module 200 to drive the air-conduction core module 300 to vibrate, thereby reducing the influence of the counterweight of the air-conduction core module 300 on the vibration of the bone-conduction core module 200, thereby ensuring the bone-conduction effect of the loudspeaker assembly 10.

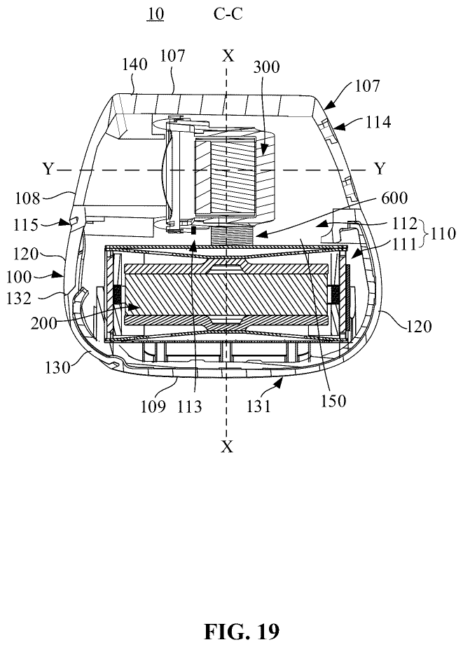

In some embodiments, as shown in FIG. 19, a resilient cushioning member 600 may be provided between the air-conduction core module 300 and the bone-conduction core module 200. The resilient cushioning member 600 may be an element such as an elastomer (e.g., silicone, rubber, etc.), a spring, an airbag, a magnetic fluid, etc. Such an arrangement may, on the one hand, reduce the vibration influence and restriction of the air-conduction core module 300 on the bone-conduction core module 200, so that the bone-conduction core module 200 may vibrate more freely and vibrate better, and on the other hand, the resilient cushioning member 600 may protect the air-conduction core module 300.

In some embodiments, at least one of the air-conduction core module 300 and the bone-conduction core module 200 is fixed relative to the housing assembly 100. Optionally, the air-conduction core module 300 and the bone-conduction core module 200 are fixedly connected to the housing assembly 100, respectively. In such cases, the stability of the operation of the bone-conduction core module 200 and the air-conduction core module 300 may be improved.

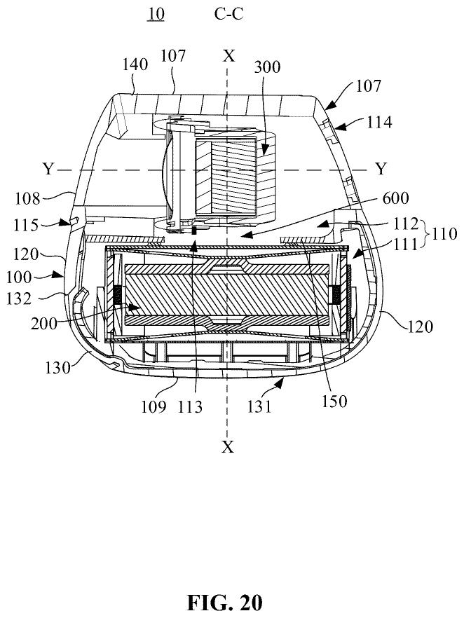

In some embodiments, as shown in FIG. 20, the air-conduction core module 300 may be spaced apart from the bone-conduction core module 200 in the first vibration direction. In this way, on the one hand, the influence of the weight of the air-conduction core module 300 on biasing the vibration generated by the bone-conduction core module 200 is reduced, and on the other hand, the air-conduction core module 300 and the bone-conduction core module 200are spaced apart, which can reduce the influence of vibration of the air-conduction core module 300 and the bone-conduction core module 200 on each other and reduce the possibility of vibration interference. Optionally, the air-conduction core module 300 may be fixedly connected to the housing assembly 100. When the bone-conduction core module 200 drives the housing assembly 100 to vibrate, the housing assembly 100 further drives the air-conduction core module 300 to vibrate.

Optionally, the housing assembly 100 may be provided with a partition wall 150, and the accommodation space 110 may include a first accommodation cavity 111 and a second accommodation cavity 112 spaced apart by the partition wall 150. The bone-conduction core module 200 is provided in the first accommodation cavity 111, and the air-conduction core module 300 is provided in the second accommodation cavity 112.

Optionally, as shown in FIG. 19, the housing assembly 100 includes a first housing 120, a second housing 130, and a third housing 140. The second housing 130 is connected to the first housing 120 and cooperates with the first housing 120 to form the first accommodation cavity 111. The third housing 140 is connected to the first housing 120 and the second housing 130, respectively, and cooperates with the first housing 120 to form the second accommodation cavity 112. With the above-described setup, it is possible to make the loudspeaker assembly 10 easy to install and disassemble.

Because the bone-conduction core module 200 requires an environment with a strong sealing performance to ensure the bone-conduction effect, the bone-conduction effect of the bone-conduction core module 200 may be improved by setting the bone-conduction core module 200 and the air-conduction core module 300 in different cavities. Optionally, the first accommodation cavity 111 may be sealed to make the first accommodation cavity 111 have better sealing performance.

Optimally, the shape and size of the first accommodation cavity 111 match the shape and size of the bone-conduction core module 200, which reduces the size of the loudspeaker assembly 10 and facilitates the bone-conduction core module 200 to drive the housing assembly 100 to vibrate and transmit the bone-conduction to the human body of the user.

In some embodiments, as shown in FIG. 20, the air-conduction core module 300 may vibrate in the second vibration direction, and the housing assembly 100 is provided with a sound outlet hole 114 and a pressure relief hole 115 that are in flow communication with the second accommodation cavity 112. The sound output hole 114 is configured to conduct a portion of the sound waves generated by the air-conduction loudspeaker 300 to the outside of the loudspeaker assembly 10, and the second accommodation cavity 112 is in flow communication with the external environment through the pressure relief hole 115 to ensure the air pressure balance in the second accommodation cavity 112, thereby reducing air pressure accumulation that affects the sound effect produced by the air-conduction loudspeaker 300.

The sound outlet hole 114 and the pressure relief hole 115 are provided on two side walls of the housing assembly 100 spaced apart from each other in the second vibration direction, and such a setting may reduce the mutual interference between sound waves propagated by the sound outlet hole 114 and the pressure relief hole 115, thereby improving the sound quality of the loudspeaker assembly 10.

In some embodiments, as shown in FIG. 20, the bone-conduction core module 200 may have a first central axis X extending along the first vibration direction. The air-conduction core module 300 may vibrate in the second vibration direction and may have a second central axis Y extending along the second vibration direction. An angle between the first central axis X and the second central axis Y may be within a range of 70°-100°.

For example, the angle between the first central axis X and the second central axis Y may be 80°, 85°, 90°, or the like. Optionally, the angle between the first central axis X and the second central axis Y may be 90°, and such a setting may reduce the interaction between the vibration of the bone-conduction core module 200 and the vibration of the air-conduction core module 300, thereby ensuring the sound quality effect of the loudspeaker assembly 10.

In some embodiments, as shown in FIG. 20, the second housing 130 may have a contact region 131 contacting the face of the user in a wearing state. A joint seam 132 between the first housing 120 and the second housing 130 is located outside the contact region 131. Providing the joint seam 132 between the first housing 120 and the second housing 130 outside the contact region 131 instead of in the contact region 131 may make the joint seam 132 not easy to clamp the skin of the human body when the headphone 1 is used.

In some embodiments, the air-conduction core module 300 and the bone-conduction core module 200 may be arranged along the first vibration direction. Optionally, the projection of the bone-conduction core module 200 on a reference plane perpendicular to the first vibration direction may have an overlapping region with the projection of the air-conduction core module 300 on the reference plane perpendicular to the first vibration direction.

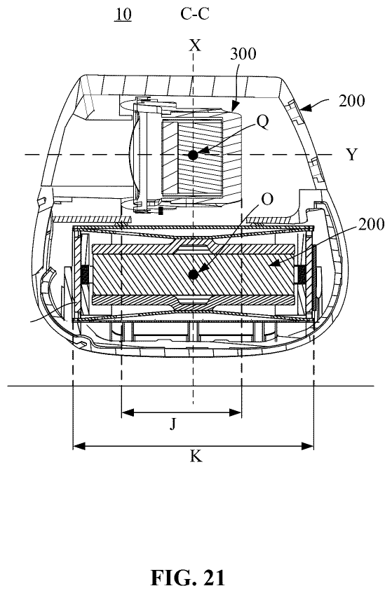

As shown in FIG. 21, the projection of the bone-conduction core module 200 on the reference plane perpendicular to the first vibration direction may be shown as K in FIG. 21, the projection of the air-conduction core module 300 on the reference plane perpendicular to the first vibration direction may be shown as J in FIG. 21, and J has an overlapping portion with K. The above-described setting can facilitate the bone-conduction core module 200 to drive the air-conduction core module 300 to vibrate when it vibrates in the first vibration direction.

The bone-conduction core module 200 has a relatively compact structure so that the mass is more concentrated and uniform, and the vibration of the air-conduction core module 300 mainly comes from the vibration diaphragm 310, which occupies a larger space but has a lighter mass. The mass of the air-conduction core module 300 is mainly concentrated on a side of the air-conduction core module 300 that is away from the vibration diaphragm 310 (i.e., a side of the air-conduction core module 300 that is close to the magnetic circuit assembly 322), and the volumes of the bone-conduction core module 200 and the air-conduction core module 300 are specifically designed according to the acoustic requirements. Therefore, the overlapping region between the bone-conduction core module 200 and the air-conduction core module 300 in the direction perpendicular to the first vibration direction is designed as follows.

Optionally, a ratio of an area of the overlapping region to an area of the projection of the air-conduction core module 300 on the reference plane may be greater than 20%, or greater than 40, or greater than 60%. For example, the ratio of the area of the overlapping region to the area of the projection of the air-conduction core module 300 on the reference plane may be 25%, 45%, 50%, or 100%.

Optionally, a ratio of the area of the overlapping region to the area of the projection of the bone-conduction core module 200 on the reference plane is greater than 20%, or greater than 40, or greater than 60%. For example, the ratio of the overlapping region and the area of the projection of the bone-conduction core module 200 on the reference plane may be 25%, 45%, 50%, or 100%.

The arrangement of the air-conduction core module 300 and the bone-conduction core module 200 can effectively make most of the weight of the air-conduction core module 300 fall on the bone-conduction core module 200 in the first vibration direction, which may reduce the influence of the air-conduction core module 300 on the vibration of the bone-conduction core module 200, thereby improving the vibration effect of the bone-conduction core module 200 and enhancing the bone-conduction sound quality effect of the bone-conduction core module 200.

In some embodiments, as shown in FIG. 21, a distance between a projection of a center of mass of the bone-conduction core module 200 on the reference plane perpendicular to the first vibration direction and a projection of a center of mass of the air-conduction core module 300 on the reference plane may be less than 0.5 mm. The center of mass of the bone-conduction core module 200 may be shown as point O in FIG. 20, and the center of mass of the air-conduction core module 300 is shown as point Q in FIG. 20.

The smaller the distance between the center of mass of the bone-conduction core module 200 and the center of mass of the air-conduction core module 300 in the direction perpendicular to the first vibration direction, the smaller the influence of the weight bias of the air-conduction core module 300 on the vibration of the bone-conduction core module 200, then the more effective the vibration, and the better the sound quality effect.

Optionally, the distance may be within a range of 0-0.4 mm or 0-0.2 mm. For example, as shown in FIG. 20, the distance between the center of mass of the bone-conduction core module 200 and the center of mass of the air-conduction core module 300 may be 0 mm. That is, the center of mass of the air-conduction core module and the center of mass of the bone-conduction core module are all located in the first vibration direction, i.e., on the reference plane perpendicular to the first vibration direction, the center of mass of the air-conduction core module 300 completely overlaps with the center of mass of the bone-conduction core module 200. Setting the distance between the center of mass in this manner reduces the different torques generated by the vibration of the bone-conduction core module 200 and the air-conduction core module 300, which enables the bone-conduction core module to have a better bone-conduction effect and the loudspeaker assembly 10 to have a better sound quality effect.

In other embodiments, the distance between the projection of the center of mass of the air-conduction core module 300 and the projection of the center of mass of the bone-conduction core module 200 on the reference plane perpendicular to the first vibration direction may be 0.1 mm, 0.25 mm, 0.3 mm, etc., which will not be specifically enumerated in this embodiment.

Alternatively, the bone-conduction core module 200 may have a first central axis X, with the first vibration direction being in the direction of the first central axis X. A distance between the center of mass of the air-conduction core module 300 and the first central axis X is less than or equal to 0.5 mm. Similarly, the closer the center of mass of the air-conduction core module 300 is to the first central axis X, the less the air-conduction core module 300 affects the vibration of the bone-conduction core module 200.

For example, optionally, as shown in FIG. 20, the distance between the center of mass of the air-conduction core module 300 and the first central axis X may be equal to 0 mm. Setting the distance between the center of mass of the air-conduction core module 300 and the first central axis X in this way may facilitate the bone-conduction core module 200 to drive the air-conduction core module 300 to vibrate together in the direction of the first central axis X, which may enable the bone-conduction loudspeaker 200 to have a better bone-conduction effect, and enable the loudspeaker assembly 10 to have a better sound quality effect.

Similarly, in other embodiments, the distance between the center of mass of the air-conduction core module 300 and the first central axis X may also be 0.1 mm, 0.2 mm, 0.3 mm, etc., which will not be specifically enumerated herein in this embodiment.

In some embodiments, as shown in FIG. 21, the bone-conduction core module 200 may have a sealed structure, and the interior of the bone-conduction core module 200 and the accommodation space 110 may be isolated from each other.

Optionally, as shown in FIG. 8 and FIG. 9, the bone-conduction core module 200 may include a cylindrical housing 210, a drive assembly 220, and two sealing plates 230. The cylindrical housing 210 is fixedly connected to the housing assembly 100, the drive assembly 220 is provided in the cylindrical housing 210, and the drive assembly 220 is configured to drive the cylindrical housing 210 to vibrate and thus drive the housing assembly 100 to vibrate. Two sealing plates 230 are respectively provided at two ends of the cylindrical housing 210 and seal the cylindrical housing 210 to form the sealed structure.

The vibration of the drive assembly 220 in the sealed cylindrical housing 210 may make the drive assembly 220 less susceptible to air resistance and other factors during the vibration process, which ensures that the bone-conduction core module 200 has a better bone-conduction effect. When the headphone 1 is dropped and hit, the sealed cylindrical housing 210 may also prevent the drive assembly 220 from falling out of the cylindrical body 210 and causing damage to the internal structure, thus improving the structural stability of the bone-conduction core module 200, thereby improving the structural stability of the bone-conduction module.

Optionally, the bone-conduction core module 200 may include a vibration transmission plate 223, the drive assembly 220 includes a voice coil assembly 221 and a magnet assembly 222, the voice coil assembly 221 is sleeved on the magnet assembly 222, the vibration transmission plate 223 is fixedly connected to the cylindrical housing 210 and the magnet assembly 222, and the voice coil assembly 221 is fixedly connected to the cylindrical housing 210. The voice coil assembly 221 is configured to receive an electrical signal and interact with the magnet assembly 222 to cause the magnet assembly 222 to vibrate, the magnet assembly 222 is configured to drive the cylindrical housing 210 to vibrate after interacting with the voice coil assembly 221, and the vibration transmission plate 223 is configured to limit the position of the magnet assembly 222. Specifically, the two sealing plates 230 are covered on the cylindrical housing 210 to form a sealed structure to better constrain the direction of the magnetic field, making the vibration of the magnet assembly 222 more sensitive, and preventing the vibration transmission plate 223 and the magnet assembly 222 from falling out of the cylindrical housing 210.

In some embodiments, the magnetic fluid may occupy at least a portion of the inner space of the cylindrical housing 210. The magnetic fluid is also referred to as a magnetic liquid, a ferromagnetic fluid, or a ferrofluid, the magnetic fluid has the fluidity of a liquid and the magnetism of a solid magnetic material, and the magnetic fluid has a better magnetic permeability compared to air, which increases the magnetic field effect of the magnet assembly 222, making the vibration of the magnet assembly 222 more sensitive. Therefore, the bone-conduction effect of the bone-conduction core module 200 and the sound quality effect of the loudspeaker assembly 10 are improved.

Optionally, the magnetic fluid may not fully fill the inner space of the cylindrical housing 210, and such a setup reduces fluid resistance and improves the bone-conduction effect of the bone-conduction core module 200.

Based on the above embodiments, the headphone 1 may include a loudspeaker assembly 10 in each of the above embodiments.

In summary, in the present disclosure, by providing the air-conduction core module 300 and the bone-conduction core module 200 in the first vibration direction of the bone-conduction core module 200 and providing the air-conduction core module 300 and the bone-conduction core module 200 along the first vibration direction and face each other, the mass of the air-conduction core module 300 may be more concentrated on the axis of the bone-conduction core module 200, so that the biasing effect of the air-conduction core module 300 on the vibration of the bone-conduction core module 200 is weakened. Thus, the bone-conduction core module 200 can better drive the air-conduction core module 300 to move when vibrating, the effect of the mass of the air-conduction core module 300 on the vibration effect of the bone-conduction core module 200 may be reduced, and the volume of the sound may be increased, thereby improving the bone-conduction effect of the loudspeaker assembly and the sound quality effect of the loudspeaker assembly 10.

The foregoing is only a part of the embodiments of the present disclosure and is not intended to limit the scope of protection of the present disclosure. Any equivalent device or equivalent process transformations utilizing the contents of the present disclosure and the accompanying drawings or applying them directly or indirectly in other related fields of technology. All of them are similarly included in the scope of patent protection of the present disclosure.

1. A loudspeaker assembly, comprising:
a housing assembly provided with an accommodation space;
a bone-conduction core module provided in the accommodation space, wherein the bone-conduction core module vibrates in a first vibration direction; and
an air-conduction core module provided in the accommodation space, wherein:
the air-conduction core module and the bone-conduction core module are arranged along the first vibration direction and face each other;
the air-conduction core module vibrates in a second vibration direction; and
an angle between the first vibration direction and the second vibration direction is within a range of 70°-100°.

2. The loudspeaker assembly of claim 1, wherein
a projection of the bone-conduction core module on a reference plane perpendicular to the first vibration direction has an overlapping region with a projection of the air-conduction core module on the reference plane perpendicular to the first vibration direction;
a ratio of an area of the overlapping region to an area of the projection of the air-conduction core module on the reference plane is greater than 20%; and/or
a ratio of the area of the overlapping region to an area of the projection of the bone-conduction core module on the reference plane is greater than 20%.

3. (canceled)

4. The loudspeaker assembly of claim 1, wherein
the air-conduction core module is stacked on the bone-conduction core module along the first vibration direction.

5. The loudspeaker assembly of claim 4, wherein
the air-conduction core module is fixedly connected to the bone-conduction core module.

6. The loudspeaker assembly of claim 4, wherein
a resilient cushioning member is provided between the air-conduction core module and the bone-conduction core module.

7. (canceled)

8. The loudspeaker assembly of claim 1, wherein
the housing assembly is provided with a partition wall, the accommodation space includes a first accommodation cavity and a second accommodation cavity spaced apart by the partition wall;
the bone-conduction core module is provided in the first accommodation cavity, and the air-conduction core module is provided in the second accommodation cavity;
the housing assembly includes a first housing, a second housing, and a third housing,
the second housing is connected to the first housing and cooperates with the first housing to form the first accommodation cavity, and
the third housing is connected to the first housing and the second housing, respectively, and cooperates with the first housing to form the second accommodation cavity.

9. (canceled)

10. The loudspeaker assembly of claim 8, wherein
the bone-conduction core module has a first central axis extending along the first vibration direction;
the air-conduction core module has a second central axis extending along the second vibration direction;
an angle between the first central axis and the second central axis is within a range of 70°-100°;
the third housing is located on a side of the first housing away from the second housing in the first vibration direction; and
a cross-section of the third housing in a direction perpendicular to the first vibration direction is progressively decreases or decreases stepwise in a direction away from the second housing.

11. The loudspeaker assembly of claim 8, wherein
the second housing has a contact region contacting the face of a user in a wearing state; and
a joint seam between the first housing and the second housing is located outside the contact region.

12. The loudspeaker assembly of claim 8, wherein
the housing assembly is provided with a sound outlet hole and a pressure relief hole that are in flow communication with the second accommodation cavity, and
the sound outlet hole and the pressure relief hole are provided on two sidewalls of the housing assembly spaced apart from each other in the second vibration direction, respectively.

13. (canceled)

14. The loudspeaker assembly of claim 1, wherein
at least one of the air-conduction core module and the bone-conduction core module is fixed relative to the housing assembly.

15. The loudspeaker assembly of claim 1, wherein
the bone-conduction core module has a sealed structure, with an interior of the bone-conduction core module being isolated from the accommodation space;
the bone-conduction core module includes a cylindrical housing, a drive assembly, and two sealing plates;
the cylindrical housing is fixedly connected to the housing assembly, the drive assembly is provided within the cylindrical housing and is configured to drive the cylindrical housing to vibrate and thereby driving the housing assembly to vibrate; and
the two sealing plates are provided at two ends of the cylindrical housing and configured to seal the cylindrical housing to form the sealed structure.

16. (canceled)

17. The loudspeaker assembly of claim 15, wherein
the bone-conduction core module includes a vibration transmission plate,
the drive assembly includes a voice coil assembly and a magnet assembly, the voice coil assembly is sleeved on the magnet assembly,
the vibration transmission plate is fixedly connected between the cylindrical housing and the magnet assembly, and
the voice coil assembly is fixedly connected to the cylindrical housing.

18. The loudspeaker assembly of claim 8, wherein
an inner space of the cylindrical housing is filled with a magnetic fluid, and the magnetic fluid occupies at least a portion of the inner space of the cylindrical housing.

19. The loudspeaker assembly of claim 1, wherein
a distance between a projection of a center of mass of the bone-conduction core module on a reference plane perpendicular to the first vibration direction and a projection of a center of mass of the air-conduction core module on the reference plane is less than 0.5 mm; or
the bone-conduction core module has a first central axis extending along the first vibration direction, and a distance between the center of mass of the air-conduction core module and the first central axis is less than or equal to 0.5 mm.

20. (canceled)

21. (canceled)

22. The loudspeaker assembly of claim 1, wherein
the housing assembly is provided with a first side surface, a second side surface, and a vibration transmitting surface,
the first side surface, the second side surface, and the vibration transmitting surface are not coplanar,
the first side surface and the second side surface are spaced apart in a direction perpendicular to the first vibration direction,
the housing assembly is provided with a sound outlet hole penetrating the first side surface and in flow communication with the accommodation space, and a pressure relief hole penetrating the second side surface and in flow communication with the accommodation space,
the vibration transmitting surface is perpendicular to the first vibration direction, and
the bone-conduction core module transmits vibration outwardly through the vibration transmitting surface.

23. (canceled)

24. A headphone, comprising the loudspeaker assembly of claim 1.

25. The loudspeaker assembly of claim 8, wherein a connecting hole is provided on the partition wall, the first accommodation cavity is in flow communication with the second accommodation cavity through connecting hole.

26. The loudspeaker assembly of claim 25, wherein the bone-conduction loudspeaker blocks the connecting hole on a side of the partition wall facing the first accommodation cavity.

27. The loudspeaker assembly of claim 26, wherein the bone-conduction loudspeaker is pressed against the partition wall to seal the connecting hole 113.

28. The loudspeaker assembly of claim 26, wherein a sealing member is provided between the bone-conduction loudspeaker and the partition wall, with the sealing member being provided around the connecting hole.
